(19) United States
(12) Patent Application Publication
(10) Pub. No.: US 2025/0080298 A1
(43) Pub. Date: Mar. 6, 2025

(54) USER EQUIPMENT (UE)-ASSISTED TIME AND PHASE SYNCHRONIZATION FOR COHERENT JOINT TRANSMISSION

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Zhifei FAN, San Diego, CA (US)

(21) Appl. No.: 18/458,897

(22) Filed: Aug. 30, 2023

(51) Int. Cl. H04L 5/00; H04W 56/00

(52) U.S. Cl. CPC H04L 5/0051; H04W 56/0015

(57) ABSTRACT

Methods, systems, and devices for wireless communication are described that support user equipment (UE)-assisted transmission and reception point (TRP) synchronization. A first TRP and a second TRP may send a first downlink reference signal (RS) and a second downlink RS to an assisting UE. The assisting UE may transmit a first uplink RS to the first TRP and a second uplink RS to the second TRP, where the first uplink RS and the second uplink RS are precoded based on the first downlink RS and the second downlink RS. A central node may calculate a relative timing offset, relative phase offset, or both, between the first TRP and the second TRP based on the first uplink RS and the second uplink RS. Then, one of the first TRP or the second TRP may use the relative timing offset, phase offset, or both to synchronize with the other TRP.

### FIELD OF TECHNOLOGY

The following relates to wireless communication, including user equipment (UE)-assisted time and phase synchronization for coherent joint transmission (CJT).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, transmission reception points (TRPs) may communicate with each other and with one or more UEs. Network entities, base stations, radio units (RUs), and other entities may be examples of TRPs capable of such communications.

### SUMMARY

The described techniques relate to improved methods, systems, devices, and apparatuses that support user equipment (UE)-assisted time and phase synchronization for coherent joint transmission (CJT). For example, the described techniques provide for UE-assisted transmission and reception point (TRP) synchronization, where a UE is capable of assisting two or more TRPs to identify and mitigate a possible transmission and reception mismatch between the two or more TRPs. For example, the present disclosure describes techniques for accurately and efficiently estimating a time offset and/or a phase offset for synchronizing two or more TRPs. In some examples, a first TRP may send a first downlink reference signal (RS) to an assisting UE, and the assisting UE may transmit a first uplink RS to the first TRP, where the first uplink RS may be precoded (e.g., by the assisting UE) based on the first downlink RS. The assisting UE may also receive a second downlink RS from a second TRP, and transmit a second uplink RS to the second TRP, where the second uplink RS may be precoded based on the second downlink RS. The uplink RS precoding performed by the assisting UE may reduce or eliminate the impact of the phase of the channel used to transmit the first uplink RS and the second uplink RS. A central node (e.g., one of the first TRP or the second TRP, or a separate entity or other network device) may calculate a relative timing offset, “p,” and relative phase offset, “p,” for the first TRP and the second TRP based on the first uplink RS and the second uplink RS. Then, one of the first TRP or the second TRP may use the relative timing offset, the relative phase offset, or both, to synchronize with the other of the first TRP and the second TRP. The techniques described herein also apply to a network of multiple TRPs and one or more assisting UEs.

A method for wireless communication by a first TRP is described. The method may include transmitting, to a first UE, a first downlink RS via a first set of resources and receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

A first TRP for wireless communication is described. The first TRP may include one or more memories storing processor executable code, and one or more processors coupled with the one or more memories. The one or more processors may individually or collectively operable to execute the code to cause the first TRP to transmit, to a first UE, a first downlink RS via a first set of resources and receive, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

Another first TRP for wireless communication is described. The first TRP may include means for transmitting, to a first UE, a first downlink RS via a first set of resources and means for receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

A non-transitory computer-readable medium storing code for wireless communication is described. The code may include instructions executable by one or more processors to transmit, to a first UE, a first downlink RS via a first set of resources and receive, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

Some examples of the method, first TRPs, and non-transitory computer-readable medium described herein may further include operations, features, means, or instructions for receiving, from the second TRP, a message indicating the second precoded uplink RS and estimating the phase offset, the timing offset, or both, based on a product of the first precoded uplink RS and a conjugate of the second precoded uplink RS.

In some examples of the method, first TRPs, and non-transitory computer-readable medium described herein, the estimation of the phase offset, the timing offset, or both may be based on a computation of the product of the first precoded uplink RS and the conjugate of the second precoded uplink RS for a set of multiple subcarriers.

In some examples of the method, first TRPs, and non-transitory computer-readable medium described herein, outputting, to a central node, a first message indicating the first precoded uplink RS and obtaining a second message indicating an estimation of the phase offset, the timing offset, or both, from the central node in response to the first message, where the estimation of the phase offset, the timing offset, or both may be based on a product of the first precoded uplink RS and a conjugate of the second precoded uplink RS.

In some examples of the method, first TRPs, and non-transitory computer-readable medium described herein, the estimation of the phase offset, the timing offset, or both may be based on a computation of the product of the first precoded uplink RS and the conjugate of the second precoded uplink RS for a set of multiple subcarriers.

In some examples of the method, first TRPs, and non-transitory computer-readable medium described herein, the central node includes one of the second TRP or another network entity.

In some examples of the method, first TRPs, and non-transitory computer-readable medium described herein, the second precoded uplink RS may be associated with a second downlink RS that corresponds to a third set of resources and the method, apparatuses, and non-transitory computer-readable medium may include further operations, features, means, or instructions for obtaining the phase offset, the timing offset, or both based on a product of the first precoded uplink RS and a conjugate of the second precoded uplink RS, and further based on a subcarrier spacing index associated with the first set of resources, the second set of resources, the third set of resources, the fourth set of resources, or any combination thereof.

In some examples of the method, first TRPs, and non-transitory computer-readable medium described herein, a frequency resource of the first set of resources may have a same frequency as a corresponding frequency resource of the third set of resources, or a frequency resource of the second set of resources may have a same frequency as a corresponding frequency resource of the fourth set of resources, or both.

In some examples of the method, first TRPs, and non-transitory computer-readable medium described herein, a time resource of the first set of resources may be the same as a corresponding time resource of the third set of resources, or a time resource of the second set of resources may be the same as a corresponding time resource of the fourth set of resources, or both.

In some examples of the method, first TRPs, and non-transitory computer-readable medium described herein, a time resource of the first set of resources may be the same as a corresponding time resource of the third set of resources and a frequency resource of the second set of resources may have a same frequency as a corresponding frequency resource of the fourth set of resources.

Some examples of the method, first TRPs, and non-transitory computer-readable medium described herein may further include operations, features, means, or instructions for determining a threshold timing offset associated with synchronization based on a frequency spacing between the first set of resources, the second set of resources, the third set of resources, the fourth set of resources, or a combination thereof and determining a threshold offset resolution based on a bandwidth for the first precoded uplink RS, the second precoded uplink RS, the first downlink RS, the second downlink RS, or any combination thereof.

Some examples of the method, first TRPs, and non-transitory computer-readable medium described herein may further include operations, features, means, or instructions for synchronizing a timing or a phase, or both, with a third TRP based on a second phase offset, a second timing offset, or both, between the second TRP and a third TRP, where the first TRP synchronizes with the third TRP using a combination of the phase offset and the second phase offset, a combination of the timing offset and the second timing offset, or both.

In some examples of the method, first TRPs, and non-transitory computer-readable medium described herein, the second phase offset, the second timing offset, or both, may be based on a third precoded uplink RS transmitted from a second UE to the second TRP and a fourth precoded uplink RS transmitted from the second UE to the third TRP.

Some examples of the method, first TRPs, and non-transitory computer-readable medium described herein may further include operations, features, means, or instructions for transmitting, to the first UE, a control message including an indication that the first set of resources for the first downlink RS may be associated with the second set of resources for the first precoded uplink RS.

Some examples of the method, first TRPs, and non-transitory computer-readable medium described herein may further include operations, features, means, or instructions for receiving capability signaling indicating a capability of the first UE to provide the first precoded uplink RS to the first TRP to assist with synchronization of the first TRP and the second TRP.

In some examples of the method, first TRPs, and non-transitory computer-readable medium described herein, the capability signaling indicates a capability of the first UE to support simultaneous downlink RS reception, a capability of the first UE to support simultaneous uplink RS transmission, one or more RS structures the first UE supports, a range of time and frequency resources that transmission and reception characteristics of the first UE may be consistent, a maximum quantity of TRPs to which the first UE may be capable of providing precoded uplink RSs, a capability of the first UE to maintain reception phase continuity and transmission phase continuity in a quantity of symbols, or any combination thereof.

In some examples of the method, first TRPs, and non-transitory computer-readable medium described herein, the first downlink RS includes one of a tracking reference signal, a positioning reference signal, a synchronization signal block (SSB), or a demodulation reference signal (DMRS).

A method for wireless communication by a first UE is described. The method may include receiving, from a first TRP, a first downlink RS via a first set of resources, transmitting, to the first TRP, a first precoded uplink RS via a second set of resources that is associated with the first set of resources, where the first precoded uplink RS is precoded based on an estimation of the first downlink RS, receiving, from a second TRP, a second downlink RS via a third set of resources, and transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

A first UE for wireless communication is described. The first UE may include one or more memories storing processor executable code, and one or more processors coupled with the one or more memories. The one or more processors may individually or collectively operable to execute the code to cause the first UE to receive, from a first TRP, a first downlink RS via a first set of resources, transmit, to the first TRP, a first precoded uplink RS via a second set of resources that is associated with the first set of resources, where the first precoded uplink RS is precoded based on an estimation of the first downlink RS, receive, from a second TRP, a second downlink RS via a third set of resources, and transmit, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

Another first UE for wireless communication is described. The first UE may include means for receiving, from a first TRP, a first downlink RS via a first set of resources, means for transmitting, to the first TRP, a first precoded uplink RS via a second set of resources that is associated with the first set of resources, where the first precoded uplink RS is precoded based on an estimation of the first downlink RS, means for receiving, from a second TRP, a second downlink RS via a third set of resources, and means for transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

A non-transitory computer-readable medium storing code for wireless communication is described. The code may include instructions executable by one or more processors to receive, from a first TRP, a first downlink RS via a first set of resources, transmit, to the first TRP, a first precoded uplink RS via a second set of resources that is associated with the first set of resources, where the first precoded uplink RS is precoded based on an estimation of the first downlink RS, receive, from a second TRP, a second downlink RS via a third set of resources, and transmit, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

In some examples of the method, first user equipment UEs, and non-transitory computer-readable medium described herein, a frequency resource of the first set of resources may have a same frequency as a corresponding frequency resource of the third set of resources, a frequency resource of the second set of resources may have a same frequency as a corresponding frequency resource of the fourth set of resources, or both.

In some examples of the method, first user equipment UEs, and non-transitory computer-readable medium described herein, a time resource of the first set of resources may be the same as a corresponding time resource of the third set of resources, a time resource of the second set of resources may be the same as a corresponding time resource of the fourth set of resources, or both.

In some examples of the method, first user equipment UEs, and non-transitory computer-readable medium described herein, a time resource of the first set of resources may be the same as a corresponding time resource of the third set of resources, and a the frequency resource of the second set of resources may have a same frequency as a corresponding frequency resource of the fourth set of resources.

Some examples of the method, first user equipment UEs, and non-transitory computer-readable medium described herein may further include operations, features, means, or instructions for receiving a control message including an indication that the first set of resources for the first downlink RS may be associated with the second set of resources for the first precoded uplink RS.

Some examples of the method, first user equipment UEs, and non-transitory computer-readable medium described herein may further include operations, features, means, or instructions for receiving control signaling including a first indication that the first set of resources for the first downlink RS may be associated with the second set of resources for the first precoded uplink RS, and a second indication that the third set of resources for the second downlink RS may be associated with the fourth set of resources for the second precoded uplink RS.

In some examples of the method, first user equipment UEs, and non-transitory computer-readable medium described herein, the control signaling includes one or more uplink RS configurations, one or more downlink reference configurations, one or more pointers associated with uplink RS resource identifiers or downlink RS identifiers, or any combination thereof.

In some examples of the method, first user equipment UEs, and non-transitory computer-readable medium described herein, the first downlink reference signal and the method, apparatuses, and non-transitory computer-readable medium may include further operations, features, means, or instructions for interpolating between the respective frequency spacings of the multiple instances of the first downlink RS and between the respective frequency spacings of the multiple instances of the second downlink RS, where the estimation of the first downlink RS and the estimation of the second downlink RS may be based on the interpolating.

Some examples of the method, first user equipment UEs, and non-transitory computer-readable medium described herein may further include operations, features, means, or instructions for transmitting capability signaling indicating a capability of the first UE to provide the first precoded uplink RS to the first TRP to assist with synchronization of the first TRP and the second TRP.

In some examples of the method, first user equipment UEs, and non-transitory computer-readable medium described herein, the capability signaling indicates a capability of the first UE to support simultaneous downlink RS reception, a capability of the first UE to support simultaneous uplink RS transmission, one or more RS structures the first UE supports, a range of time and frequency resources that transmission and reception characteristics of the first UE may be consistent, a maximum quantity of TRPs to which the first UE may be capable of providing precoded uplink RSs, a capability of the first UE to maintain reception phase continuity and transmission phase continuity in a quantity of symbols, or any combination thereof.

Some examples of the method, first user equipment UEs, and non-transitory computer-readable medium described herein may further include operations, features, means, or instructions for receiving, from a third TRP, a third downlink RS via a fifth set of resources and transmitting, to the third TRP, a third precoded uplink RS via a sixth set of resources that may be associated with the fifth set of resources, where the third precoded uplink RS may be precoded based on an estimation of the third downlink RS.

### BRIEF DESCRIPTION OF THE DRAWINGS

FIG. 1 shows an example of a wireless communications system that supports user equipment (UE)-assisted time and phase synchronization for coherent joint transmission (CJT) in accordance with one or more aspects of the present disclosure.

FIG. 2 shows an example of a wireless communications system that supports UE-assisted time and phase synchronization for CJT in accordance with one or more aspects of the present disclosure.

FIG. 3 shows an example of a wireless communications resource diagram that supports UE-assisted time and phase synchronization for CJT in accordance with one or more aspects of the present disclosure.

FIG. 4 shows an example of a process flow diagram that supports UE-assisted time and phase synchronization for CJT in accordance with one or more aspects of the present disclosure.

FIG. 5 shows an example of a wireless communications system that supports UE-assisted time and phase synchronization for CJT in accordance with one or more aspects of the present disclosure.

FIGS. 6 and 7 show examples of wireless communications resource diagrams that support UE-assisted time and phase synchronization for CJT in accordance with one or more aspects of the present disclosure.

FIGS. 8 and 9 show block diagrams of devices that support UE-assisted time and phase synchronization for CJT in accordance with one or more aspects of the present disclosure.

FIG. 10 shows a block diagram of a communications manager that supports UE-assisted time and phase synchronization for CJT in accordance with one or more aspects of the present disclosure.

FIG. 11 shows a diagram of a system including a device that supports UE-assisted time and phase synchronization for CJT in accordance with one or more aspects of the present disclosure.

FIGS. 12 and 13 show block diagrams of devices that support UE-assisted time and phase synchronization for CJT in accordance with one or more aspects of the present disclosure.

FIG. 14 shows a block diagram of a communications manager that supports UE-assisted time and phase synchronization for CJT in accordance with one or more aspects of the present disclosure.

FIG. 15 shows a diagram of a system including a device that supports UE-assisted time and phase synchronization for CJT in accordance with one or more aspects of the present disclosure.

FIGS. 16 through 19 show flowcharts illustrating methods that support UE-assisted time and phase synchronization for CJT in accordance with one or more aspects of the present disclosure.

### DETAILED DESCRIPTION

Some entities within a wireless communications system may perform synchronization procedures to ensure accurate signaling for coordinated communications within the system. For example, some transmission and reception points (TRPs) within the wireless communications system may synchronize time (e.g., clock timing, transmission timing, reception timing) and phase (e.g., signaling phase) with one another for transmission and reception. The use of such synchronizations may be increasingly impactful due to wide-spread use of time division duplexing (TDD) radio technology, coherent joint transmission (CJT), and an expansion of new network architectures in next generation and advanced wireless systems.

Some wireless communications systems (such as multi-user multi-input multi-output (MU-MIMO) systems) may be particularly sensitive to a time and/or phase mismatch between devices, such as time and phase mismatch between TRPs deployed within the system. In some cases, time and phase synchronization can be performed using over-the-air signaling between one or more TRPs of the wireless communications systems. These synchronization techniques, however, may be relatively inefficient in cases where the channel between the one or more TRPs is relatively weak, prone to interference, or affected by blockage or other impairments, among other examples. In some other cases, the network may rely on UE-assisted synchronization, where one or more assisting UEs provide synchronization information for the one or more TRPs. Such techniques, however, may be inaccurate in cases where there is a transmission and reception mismatch at the one or more assisting UEs, which may negatively impact the synchronization procedures.

In accordance with aspects of the present disclosure, a wireless communications system may employ enhanced techniques for UE-assisted TRP synchronization that account for possible transmission and reception mismatch (e.g., phase misalignment, timing misalignment) at the UE, thus providing a more accurate time and phase offset estimation for synchronizing two or more TRPs. In some aspects, a first TRP may send a first downlink reference signal (RS) to an assisting UE, and the assisting UE may transmit a first uplink RS to the first TRP, where the first uplink RS may be precoded based on the first downlink RS. The assisting UE may also receive a second downlink RS from a second TRP, and may transmit a second uplink RS to the second TRP, where the second uplink RS may be precoded based on the second downlink RS. The uplink RS precoding performed by the UE may remove the impact (e.g., phase misalignment) of the channel used to transmit the first uplink RS and the second uplink RS. Then, a central node (e.g., one of the first TRP and the second TRP, a separate entity) may calculate a relative timing offset, “ρ,” and relative phase offset, “φ,” for the two TRPs based on the first uplink RS and the second uplink RS. Then, one of the first TRP or the second TRP may use the relative timing offset, phase offset, or both, to synchronize with the other of the first TRP and the second TRP.

Additionally, or alternatively, the techniques described herein may apply to a network of TRPs and assisting UEs. For example, a set of TRPs may be in wireless communication with a set of UEs. A first TRP of the set of TRPs may synchronize with a second TRP of the set of TRPs based one or more first offsets (e.g., time offset, phase offset) obtained via a first UE of the set of UEs, in accordance with techniques described herein. The second TRP may also synchronize with a third TRP of the set of TRPs based on one or more second offset obtained via a second UE of the set of UEs, in accordance with techniques described herein. Then, the first TRP may synchronize with the third TRP based on the first offsets and the second offsets (e.g., a combination of the first and second offsets). Accordingly, the set of TRPs may have “N” TRPs, where a first TRP of the set of TRPs may synchronize with an Nth TRP of the set of TRPs based on offsets obtained via at least N−1 UEs corresponding to N−1 pairs (e.g., N−1 unique pairs) of TRPs in the set of TRPs.

Aspects of the disclosure are initially described in the context of wireless communications systems. Additionally, aspects of the disclosure are described in the context of wireless communications resource diagrams and a process flow diagram. Aspects of the disclosure are further illustrated by and described with reference to apparatus diagrams, system diagrams, and flowcharts that relate to UE-assisted time and phase synchronization for CJT.

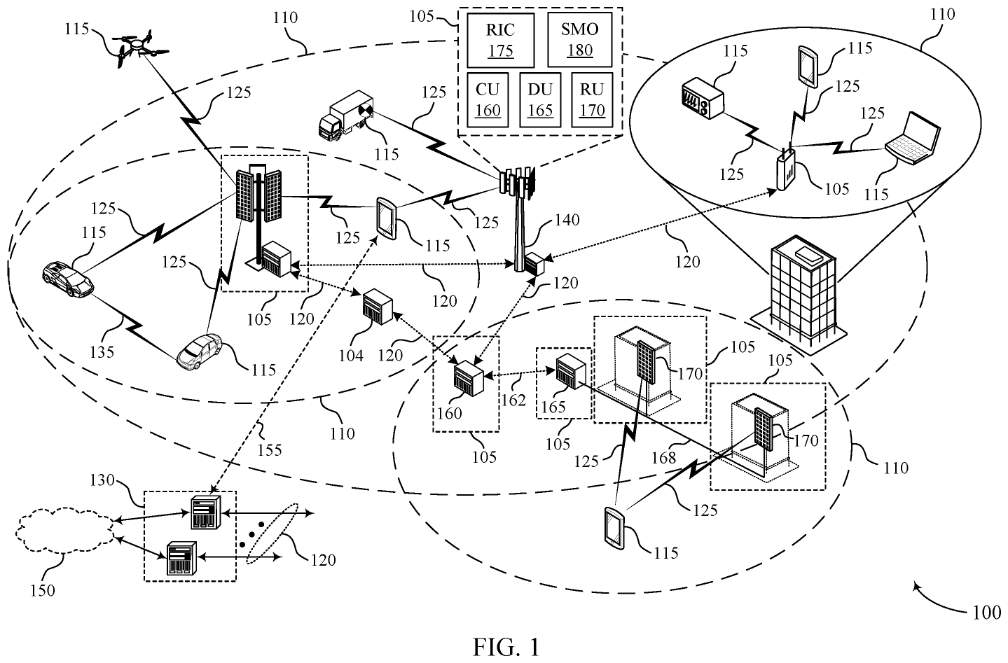

FIG. 1 shows an example of a wireless communications system 100 that supports UE-assisted time and phase synchronization for CJT in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support UE-assisted time and phase synchronization for CJT as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ−N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In accordance with aspects of the present disclosure, the wireless communications system 100 may employ enhanced techniques for UE-assisted TRP synchronization that account for possible a transmission and/or reception mismatch (e.g., phase misalignment, timing misalignment), thus providing a more accurate time and phase offset estimation for synchronizing two or more TRPs (for example, RUs 170 which may be examples of TRPs). In some cases, a first TRP may send a first downlink RS to an assisting UE 115, and the assisting UE 115 may transmit a first uplink RS to the first TRP, where the assisting UE may precode the first uplink RS based on the first downlink RS. The assisting UE 115 may also receive a second downlink RS from a second TRP, and may transmit a second, different uplink RS to the second TRP, where the assisting UE may precode the second uplink RS based on the second downlink RS. The uplink RS precoding performed by the UE may reduce or eliminate the impact (e.g., phase misalignment) of the channel used to transmit the first uplink RS and the second uplink RS. Then, a central node (e.g., one of the first TRP or the second TRP, or a separate entity or network device) may calculate a relative timing offset, p, and phase offset, p, of the two TRPs based on the first uplink RS and the second uplink RS. Then, one of the first TRP or the second TRP may use the relative timing offset, the relative phase offset, or both, to synchronize with the other of the first TRP and the second TRP.

Additionally, or alternatively, the techniques described herein may apply to a network of multiple TRPs and assisting UEs 115. For example, a set of TRPs may be in wireless communication with a set of UEs. A first TRP of the set of TRPs may synchronize with a second TRP of the set of TRPs based one or more first offsets (e.g., time offset, phase offset) obtained via a first UE 115 of the set of UEs, in accordance with techniques described herein. The second TRP may also synchronize with a third TRP of the set of TRPs based on one or more second offsets obtained via a second UE 115 of the set of UEs, in accordance with techniques described herein. Then, the first TRP may synchronize with the third TRP based on the first offsets and the second offsets (e.g., a combination of the first and second offsets). Accordingly, the set of TRPs may have N TRPs, where a first TRP of the set of TRPs may synchronize with an Nth TRP of the set of TRPs based on offsets obtained via at least N−1 UEs 115 corresponding to N−1 pairs (e.g., N−1 unique pairs) of the TRPs in the set of TRPs.

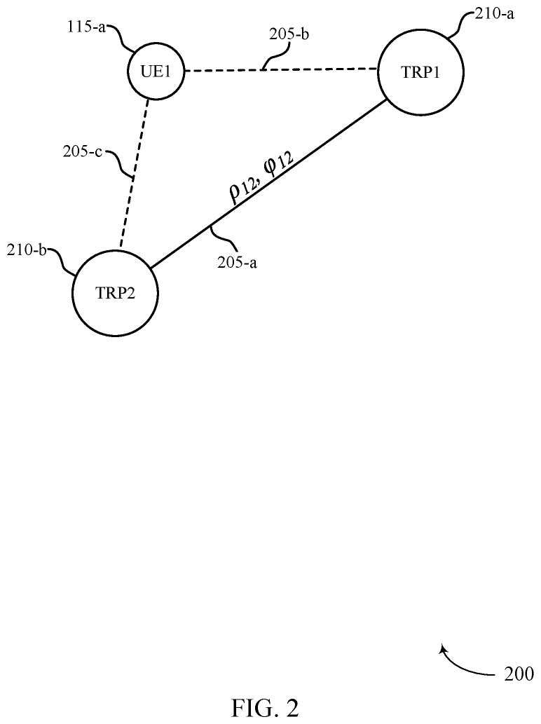

FIG. 2 shows an example of a wireless communications system 200 that supports UE-assisted time and phase synchronization for CJT in accordance with one or more aspects of the present disclosure. Aspects of the wireless communications system 200 may implement or be implemented by aspects of FIG. 1. For example, the wireless communications system 200 may include multiple TRPs 210 (e.g., a first TRP 210-a (e.g., TRP1) and a second TRP 210-a (e.g., TRP2), which may be collectively called the TRPs 210, which may each be examples of the network entity 105, the RU 170, the TRP, or other aspects described with reference to FIG. 1. Additionally, the wireless communications system 200 may include a UE 115-a (e.g., UE1), which may be an example of the UEs 115 described with reference to FIG. 1. Although certain quantities of TRPs, UEs, and other aspects are shown in the wireless communications system 200, the present disclosure may apply to any quantity of TRPs, UEs, other aspects of the wireless communications system 200, or any combination thereof.

The wireless communications system 200 may include the TRPs 210, the UE 115-a, and wireless communication links (e.g., wireless communication link 205-a, wireless communication link 205-b, and wireless communication link 205-c). In some cases, the TRP 210-a and the TRP 210-b may wirelessly communicate with one another via the wireless communication link 205-a. Additionally, or alternatively, the TRPs may communicate with the UE 115-a via other wireless communication links. For example, the TRP 210-a may communicate with the UE 115-a via the wireless communication link 205-b, and the TRP 210-b may wirelessly communicate with the UE 115-a via the wireless communication link 205-c. In some example time periods, the TRP 210-a and the TRP 210-b may suffer from a timing offset, ρ₁₂, and a phase offset, φ₁₂, when communicating via the wireless communication link 205-a.

In some cases, a first phase (e.g., phase alignment, phase synchronization, signaling phase) associated with the TRP 210-a may become misaligned with (e.g., drift from) a second phase associated with the TRP 210-b over a duration of time, causing the phase offset φ₁₂. In some cases, the first phase, the second phase, or both, may become misaligned due to relative timing drift among the TRPs, where the relative timing drift may be due to clock drift (e.g., if the TRPs 210 are not GPS-connected). Additionally, or alternatively, phase locked loop (PLL) dynamics may cause a phase drift (e.g., random phase drift) at TRP 210-a, TRP 210-b, or both (e.g., even if the TRPs 210 are GPS-connected).

In some cases, the performance of CJT by the TRPs (e.g., in distributed MIMO systems) may be impacted by (e.g., is sensitive to) the phase offset φ₁₂ (e.g., phase mismatch). That is, the performance of CJT by the TRPs when φ₂ is relatively larger may be poor compared the performance of CJT by the TRPs when φ₁₂ is smaller. For example, the wireless communications system 200 may be associated with MU-MIMO, where a set of UEs (e.g., the UE 115-a and one or more other UEs) may be served by the TRPs via the same wireless communications resources. In such examples, aspect of MU-MIMO communications, such as beam nulling and zero forcing toward UEs not of the set of UEs, may impose stringent requirements on a phase synchronization between the TRPs.

In some implementations, time synchronization and phase synchronization between the TRPs (e.g., resetting ρ₁₂ and φ₁₂ to zero by altering the phase and timing of one or more of the TRPs) may be accomplished via over-the-air (OTA) signaling between the TRPs via the wireless communication link 205-a. However, in some cases, OTA synchronization between the TRPs may not be possible due to the wireless communication link 205-a being relatively weak or degraded (e.g., poor channel conditions in the wireless communication link 205-a, the channel is weak). For example, the wireless communication link 205-a may be relatively weak due to down tilt in a macro deployment of the TRPs, or due to the wireless communication link 205-a being a non-line of sight (NLOS) wireless communication link, among other examples.

In some cases, the UE 115-a may be located near or between the TRPs 210 (e.g., within a range of both TRP 210-a and TRP 210-b), and may assist in the synchronization of the TRPs (e.g., the synchronization of the timings and phases corresponding to the TRPs). In some cases, the UE 115-a may assist in the synchronization of the TRPs due to the wireless communication links 205-b and 205-c being line of sight (LOS) connections. However, one challenge for the UE 115-a in assisting in the synchronization of the TRPs arises from a lack of transmission and reception calibration for the UE 115-a. For example, the phase, timing, or both, of a signal received by the UE 115-a may not be the same as (e.g., not synchronized with, not aligned with) a signal transmitted by the UE 115-a, and the transmission and reception channels may differ for the UE 115-a. The lack of transmission and reception calibration at the UE 115-a may cause the UE 115-a to incorrectly synchronize the TRPs (e.g., if the UE 115-a is utilized for synchronization assistance between the TRPs 210).

In the present disclosure, techniques are described to estimate the timing offset and the phase offset (e.g., phase uncertainty) between the TRPs. Additionally, or alternatively, the techniques described herein apply to wireless communications systems associated with TDD, and thus the timing offset and the phase offset of the TRPs may be with respect to the combined transmission and reception offsets. The techniques described herein additionally apply to situations where a transmission timing offset and a transmission phase offset of one of the TRPs is not the same as a reception timing offset and a reception phase offset, respectively. In some cases, the transmission offsets and the reception offsets may not be the same due to a reception clock of one of the TRPs not being the same as a transmission clock of the one of the TRPs, reception PLL dynamics of the one of the TRPs not being the same as transmission PLL dynamics of the one of the TRPs, or both. Initially, the present disclosure considers TRP 210-a, TRP 210-b, and the UE 115-a assisting in the synchronization. The present disclosure also considers extending the techniques described herein to a network of N TRPs and a network of UEs to assist in synchronization.

To accommodate the timing offset p and phase offset (p of a pair of TRPs with respect to combined transmission and reception offsets, the following equations may be utilized:

$${ρ}_{12} = {ρ}_{TRP 1}^{R} + {ρ}_{TRP 1}^{T} - ( {ρ}_{TRP 2}^{R} + {ρ}_{TRP 2}^{T} ) \qquad 1$$

$${φ}_{12} = {φ}_{TRP 1}^{R} + {φ}_{TRP 1}^{T} - ( {φ}_{TRP 2}^{R} + {φ}_{TRP 2}^{T} ) \qquad 2$$

where ρ represents a timing offset, φ represents a phase offset, the superscript of an offset (e.g., T, R) represents whether the offset is associated with transmission or reception, respectively, and the subscript of an offset represents the TRP associated with the offset (e.g., TRP 210-a, TRP 210-b). For example, ρ_{TRP1}^{R} may represent the reception timing offset associated with the TRP 210-a, whereas φ_{TRP2}^{T} may represent the transmission phase offset associated with the TRP 210-b.

In some cases, each timing offset may represent a phase ramp over subcarriers (e.g., adjacent subcarriers), where the subcarriers may be separated by a frequency difference of Δf (e.g., a subcarrier spacing), where the transmission timing offset may represent a transmission phase ramp and the reception timing offset may represent a reception phase ramp. In some cases, the frequency difference may be introduced by clock jitter of the transmission or reception clock associated with the corresponding TRP.

In some cases, each phase offset may represent a phase uncertainty introduced by clock jitter of the corresponding TRP 210. For example, the transmission phase offset may represent a phase uncertainty introduced by jitter in the transmission clock (e.g., transmission-side clock jitter) of the corresponding TRP 210. As another example, the reception phase offset may represent a phase uncertainty introduced by jitter in the reception clock (e.g., reception-side clock jitter) of the corresponding TRP 210.

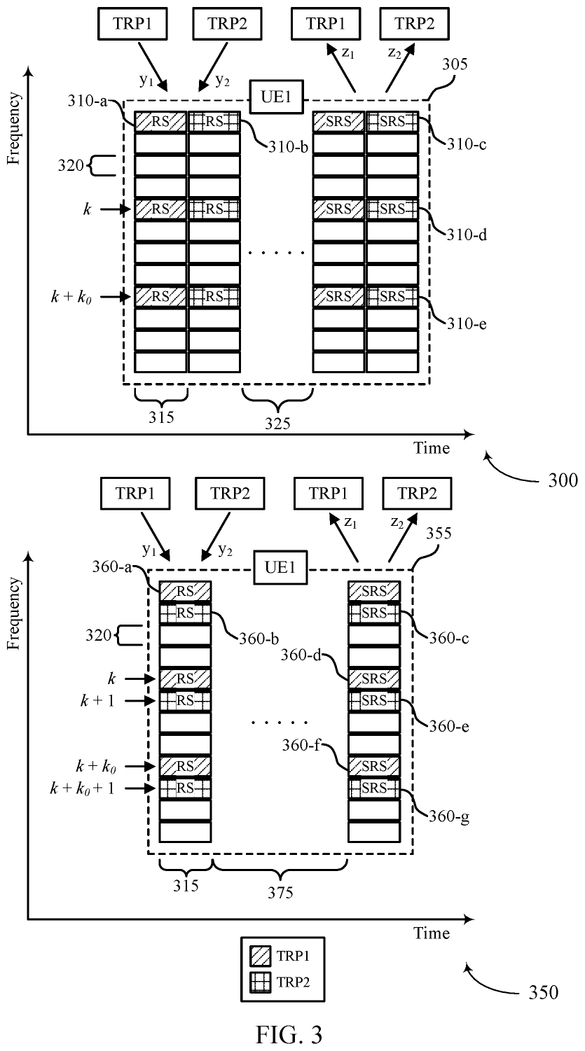

FIG. 3 shows an example of a wireless communications resource diagrams 300 and 350 that support UE-assisted time and phase synchronization for CJT in accordance with one or more aspects of the present disclosure. The wireless communications resource diagram 300 may illustrate a first example of the techniques described herein, and the wireless communications resource diagram 350 may illustrate a second example of the techniques described herein. Aspects of the wireless communications resource diagrams 300 and 350 may implement or be implemented by aspects of FIGS. 1 and 2. For example, the wireless communications resource diagrams 300 and 350 may illustrate resources for wireless communications between a first TRP (e.g., TRP1), a second TRP (e.g., TRP2), collectively called the TRPs, and a UE 115 (e.g., UE1), which may be examples of the TRP 210-a, TRP 210-b, and UE 115-a described with reference to FIG. 2, respectively, or respective UEs 115 and network devices described with reference to FIG. 1.

The wireless communications resource diagrams 300 and 350 may illustrate the UE1 receiving a first downlink RS (e.g., y₁) and a second downlink RS (e.g., y₂) from the TRP1 and TRP2 (e.g., as a result of a first downlink RS transmission from TRP1 and a second downlink RS transmission from TRP2), respectively. Additionally, the TRP1 and the TRP2 may receive a first uplink RS (e.g., z₁) and a second uplink RS (e.g., z₂) (e.g., a first SRS and a second SRS), respectively, from the UE1. A resource depiction 305 and a resource depiction 355 may show the resources (e.g., time/frequency resources) used for the first and second downlink RSs and the first and second uplink RSs. Within the resource depictions 305 and 355, each column may represent a time interval 315 (e.g., a slot, a time resource) and each row may represent one or more frequency resources 320 (e.g., a subcarrier, a resource element (RE), one or more frequency resources). Additionally, the resource depictions 305 and 355 include resources 310 and resources 360 (e.g., OFDM symbols, resource elements, time and frequency resources), respectively (e.g., resource 310-a, resource 310-b, resource 310-c, resource 310-d, resource 360-a, resource 360-b, resource 360-c, resource 360-d), where each resource 310 and 360 may correspond to a time resource and a frequency resource (e.g., a time-frequency resource), and some of the resources 310 and 360 may be used to transmit (e.g., carry or convey) an uplink RS or a downlink RS. The RSs shown in FIG. 3 may be an example of a downlink RS, and the SRSs shown in FIG. 3 may be examples of uplink RSs, however other examples of uplink RSs and downlink RSs may be considered (e.g., as described herein).

The first downlink RS and the first uplink RS may correspond to the TRP1, and may be transmitted by the TRP1 and the first uplink RS is received by the TRP1. Similarly, the second downlink RS and the second uplink RS may correspond to the TRP2, and may be transmitted by the TRP2 and the second uplink RS is received by the TRP2. To support UE-assisted time and phase synchronization for CJT in accordance with the one or more aspects of the present disclosure, the downlink RSs, the uplink RSs, or a combination thereof, may follow one or more example relationships.

A first example relationship may be that the frequency resources associated with RSs corresponding to a same TRP of the TRPs be the same or close (e.g., within a threshold frequency difference, adjacent frequency resources). For example, the first example relationship may be that the first downlink RS and the first uplink RS both be transmitted on the same frequency resource or on frequency resources close to each other. In one example, because the first uplink RS may be precoded based on the first downlink RS, transmitting the first downlink RS and the first uplink RS on the same (e.g., or close to same) frequency resource may cancel out the phase of the channel over the frequency resource (e.g., or frequency resources) used to transmit the first downlink RS and the first uplink RS. In some cases, if the frequency resource of the first downlink RS and the first uplink RS are not the same, the UE1 may interpolate between the different frequency resources to achieve acceptable results.

A second example relationship may be that the time resources associated with RSs corresponding to a same TRP of the TRPs be close to each other (e.g., within a threshold time difference, adjacent time resources, within a same slot separated by 2-3 symbols for downlink-uplink switching). For example, the first example relationship may be that the first downlink RS and the first uplink RS be transmitted on time resources close to each other. In one example, because the first uplink RS may be precoded based on the first downlink RS, transmitting the first downlink RS and the first uplink RS on time resources close to each other may cancel out the phase of the channel (e.g., given that the channel of the time resources used to transmit the first downlink RS and the first uplink RS is approximately constant if the time resources are relatively close to each other).

A third example relationship may be that the frequency resources associated with the first and second uplink RSs be the same or close, that the frequency resources associated with the first and second downlink RSs be the same or close, or both. For example, the third example relationship may be that the first downlink RS and the second downlink RS both be transmitted on the same frequency resource or on frequency resources close to each other. In one example, transmitting the first downlink RS and the second downlink RS on the same (e.g., or close to same) frequency resource may cancel out the phase offset that may arise from the lack of transmission and reception calibration at the UE1. In such an example, because the phase offset that may arise from the lack of transmission and reception calibration at the UE1 may be canceled, the remaining phase of the uplink RSs may represent the timing offset and phase offset between the TRPs.

In some cases, the downlink RSs and uplink RSs may be transmitted (e.g., repeated) periodically throughout the frequency domain. For example, resource 310-d and resource 310-e may be used for the UE1 to transmit the second uplink RS to the TRP2. The resource 310-d may be transmitted via a frequency resource k, and the resource 310-e may be transmitted via a frequency resource k+k₀, where k₀ represents a subcarrier spacing (e.g., in frequency) between the repetitions of the second uplink RS.

In some cases, the resources used for the uplink RSs and downlink RSs may impact the efficacy of the synchronization between the TRPs. The subcarrier spacing k₀ between the resource elements of the downlink RSs and the uplink RSs in the frequency domain may determine the largest timing offset that may be corrected via UE-assisted synchronization techniques, as described herein. In some instances, a larger k₀ may indicated that the UE-assisted synchronization may be able to resolve (e.g., remove, synchronize) a larger time offset. For example, if k₀=12 resource elements, the UE-assisted synchronization may be able to resolve ±1.39 μsec (e.g., assuming a 30 kHz subcarrier spacing (SCS)).

In some cases, a bandwidth associated with the uplink RSs, the downlink RSs, or both, may determine the smallest timing offset (e.g., timing offset resolution) that can be resolved (e.g., distinguished) via the UE-assisted synchronization. For example, the resource 310-a may be used for the UE1 to receive the first downlink RS from TRP1. The resource 310-a may be associated with frequency resource that has a bandwidth over which the first downlink RS is transmitted. In some cases, the larger the bandwidth for a frequency resource, the smaller the timing offset that may be resolved via the UE assisted synchronization.

Based on the example relationships, the wireless communications resource diagram 300 may illustrate a first example of the techniques described herein, whereas the wireless communications resource diagram 350 may illustrate a second example of the techniques described herein. For example, the first example of the techniques described herein may follow the first example relationship and the third example relationship, and the second example of the techniques described herein may follow the first example relationship and the second example relationship. In some cases, the first example may not require the UE1 to perform simultaneous reception or simultaneous transmission, and may be more accurate than the second example. In some cases, the second example may utilize less overhead (e.g., less time resources) and be less accurate than the first example, and may be associated with the UE1 performing simultaneous transmission and reception.

As described above, the wireless communications resource diagrams 300 and 350 may show a first example and a second example of the techniques described herein, respectively. In the wireless communications resource diagrams 300 and 350, the UE1 may receive the first downlink RS, y₁, from the TRP1 and the second downlink RS, y₂, from the TRP2. The UE1 also transmits the first uplink RS, z₁, to the TRP1 and the second uplink RS, z₂, to the TRP2. To describe y₁ and y₂, the following equations may be employed:

$${y}_{1} ( k ) = {H}_{1}^{DL} ( k ) exp ( - J 2 π k {ρ}_{TRP 1}^{T} Δ f ) exp ( - J {φ}_{TRP 1}^{T} ) {ϕ}_{UE}^{R} ( k ) + n ( k ) \qquad 3$$

$${y}_{2} ( k ) = {H}_{2}^{DL} ( k ) exp ( - J 2 π k {ρ}_{TRP 2}^{T} Δ f ) exp ( - J {φ}_{TRP 2}^{T} ) {ϕ}_{UE}^{R} ( k ) + n ( k ) , \qquad 4$$

where H₁^{DL}(k) and H₂^{DL}(k) represent a first downlink channel and a second downlink channel used to transmit the first downlink RS and the second downlink RS, respectively. Additionally, exp(−J2πkρ_{TRP1}^{T}Δf) and exp(−J2πkρ_{TRP2}^{T}Δf) may represent the phase ramping (e.g., timing offset) based on the subcarrier spacing, Δf, associated with the first channel and the second channel, respectively, and exp(−Jφ_{TRP1}^{T}) and exp(−Jφ_{TRP2}^{T}) may represent the transmission phase offset (e.g., a random phase offset) generated at the TRP1 and the TRP2, respectively. The ϕ_{UE}^{R}(k) may represent the reception phase and gain imbalance at the UE1, and n(k) may represent random noise that may affect the downlink RSs.

As described herein, the uplink RSs z₁ and z₂ are each precoded based on the downlink RS y₁ and y₂, respectively. For example, z₁ and z₂ may be described by the following equations:

$${z}_{1} ( k ) = conj ( {\hat{y}}_{1} ( k ) ) \cdot {H}_{1}^{UL} ( k ) exp ( J 2 π k {ρ}_{TRP 1}^{R} Δ f ) exp ( J {φ}_{TRP 1}^{R} ) {ϕ}_{UE}^{T} ( k ) + {w}_{1} ( k ) = {μ}_{1} {\vert {H}_{1}^{UL} ( k ) \vert}^{2} exp ( J 2 π k ( {ρ}_{TRP 1}^{R} + {ρ}_{TRP 1}^{T} ) Δ f ) exp ( J ( {φ}_{TRP 1}^{R} + {φ}_{TRP 1}^{T} ) ) {ϕ}_{UE}^{T} ( k ) conj ( {ϕ}_{UE}^{R} ( k ) ) + {w}_{1} ( k ) \qquad 5$$

$${z}_{2} ( k ) = conj ( {\hat{y}}_{2} ( k ) ) \cdot {H}_{2}^{UL} ( k ) exp ( J 2 π k {ρ}_{TRP 2}^{R} Δ f ) exp ( J {φ}_{TRP 2}^{R} ) {ϕ}_{UE}^{T} ( k ) + {w}_{2} ( k ) = {μ}_{2} {\vert {H}_{2}^{UL} ( k ) \vert}^{2} exp ( J 2 π k ( {ρ}_{TRP 2}^{R} + {ρ}_{TRP 2}^{T} ) Δ f ) exp ( J ( {φ}_{TRP 2}^{R} + {φ}_{TRP 2}^{T} ) ) {ϕ}_{UE}^{T} ( k ) conj ( {ϕ}_{UE}^{R} ( k ) ) + {w}_{2} ( k ) \qquad 6$$

where ŷ₁ and ŷ₂ represent the estimated first and second downlink RSs, respectively, as estimated by the UE1 after reception of the first and second downlink RSs. The conj(ŷ₁(k)) and conj(ŷ₂(k)) may represent the precoders that the UE uses to transmit the uplink RSs, and may be obtained from the conjugate of the estimate of the first and second downlink RS, respectively, where, if the n(k) term is small enough, is close to H₁^{DL}(k)exp(−J2πkρ_{TRP1}^{T}Δf) exp(−Jφ_{TRP1}^{T})ϕ_{UE}^{R}(k)+n(k). Additionally, H₁^{UL}(k) and H₂^{UL}(k) may represent a first uplink channel and a second uplink channel used to transmit the first uplink RS and the second uplink RS, respectively, and exp(J2πkρ_{TRP1}^{R}Δf) and exp(J2kρ_{TRP2}^{R}Δf) may represent the receive side timing offset for TRP1 and TRP2, respectively. The exp(Jφ_{TRP1}^{R}) and exp(Jφ_{TRP2}) may represent the received phase uncertainty at the TRP1 and the TRP2, respectively, the ϕ_{UE}^{T}(k) may represent the transmission phase and gain imbalance at the UE1, and the w₁(k) represents random noise in the first and second uplink RSs. The μ₁ and μ₂ may represent a scaling of the first and second uplink RSs, respectively.

In the equations shown for z₁ and z₂, the ϕ_{UE}^{T}(k)conj(ϕ_{UE}^{R}(k)) term shows that the receive and transmit phase and gain imbalance of the UE1 is transmitted at part of the uplink RSs. To remove the effect of the phase and gain imbalances of the UE1, the following equation may be employed:

$${z}_{1} ( k ) {z}_{2}^{*} ( k ) = \vert x ( k ) \vert exp ( J 2 π k {ρ}_{12} Δ f ) exp ( J {φ}_{12} ) \qquad 7$$

where z₂*(k) represents the conjugate of z₂, and |x(k)| may be:

$$\vert x ( k ) \vert = {μ}_{1} {\vert {H}_{1}^{UL} ( k ) \vert}^{2} {μ}_{2} {\vert {H}_{2}^{UL} ( k ) \vert}^{2} {\vert {ϕ}_{UE}^{T} ( k ) \vert}^{2} {\vert {ϕ}_{UE}^{R} ( k ) \vert}^{2} \qquad 8$$

which has no phase impact (e.g., just the magnitude). Additionally, ρ₁₂ and φ₁₂ may represent the timing offset and the phase offset between the TRP1 and the TRP2. Effectively, this may cancel out the transmission and reception phase and gain imbalances of the UE1.

As described herein, the Equations 1 and 2 may describe the timing offset and the phase offset between the TRP1 and the TRP2. The parameters in Equations 1 and 2 may be estimated using Equation 7 for multiple uplink RSs precoded based on the corresponding downlink RSs over multiple frequency resources (e.g., subcarriers) with the spacing (e.g., regular spacing, periodicity) of k₀ (e.g., k=0, k₀, 2k₀, 3k₀, . . . ).

In the wireless communications resource diagram 300, the downlink RSs may be received via a same frequency resource and over time resources that are close to each other, and the uplink RSs may be transmitted via the same frequency resource and over time resources that are close to each other. For example, the resources 310-a and 310-b may be used for the UE1 to receive (e.g., and the TRPs to transmit) the first downlink RS and the second downlink RS, respectively. A frequency resource associated with the resources 310-a may be the same as a frequency resource associated with the resource 310-b, and a time resource associated with the resources 310-a may be close to (e.g., adjacent to) a time resource associated with the resource 310-b.

In the wireless communications resource diagram 300, the resources 310-b and 310-c are used for the UE1 to receive (e.g., TRP2 to transmit) the second downlink RS and for the UE1 to transmit (e.g., TRP2 to receive) the second uplink RS, respectively. In some cases, the downlink RSs and the uplink RSs may be associated with a same frequency resource, and separated by a duration 325. For example, a frequency resource associated with the resource 310-b may be the same as a frequency resource associated with the resource 310-c.

As discussed above, the uplink RSs and the downlink RSs may be transmitted over a period of frequency resources. In some cases, the uplink RSs and the downlink RSs may be repeated over a period of frequency resources. For example, the resources 310-c, 310-d, and 310-e may each be used for the UE1 to transmit (e.g., TRP2 to receive) an instance of the second uplink RS. The resource 310-d may be associated with a frequency resource k (e.g., subcarrier spacing index k), counting up from a frequency resource associated with the resource 310-c. The resource 310-e may then be associated with a frequency resource k+k₀ (e.g., subcarrier spacing index k+k₀), where k₀ may represent the period (e.g., interval) of frequency over which the second uplink RS is transmitted.

In the wireless communications resource diagram 350, the downlink RSs may be received via relatively close (e.g., adjacent) frequency resources and over a same time resource, and the uplink RSs may be transmitted via close frequency resources and over a same time resource. For example, the resources 360-a and 360-b may be used for the UE1 to receive (e.g., and the TRPs to transmit) the first downlink RS and the second downlink RS, respectively. A frequency resource associated with the resources 360-a may be relatively close to (e.g., within a threshold distance from) a frequency resource associated with the resource 360-b, and a time resource associated with the resources 360-a may be the same as a time resource associated with the resource 360-b.

In the wireless communications resource diagram 350, the resources 360-b and 360-c are used for the UE1 to receive (e.g., TRP2 to transmit) the second downlink RS and for the UE1 to transmit (e.g., TRP2 to receive) the second uplink RS, respectively. In some cases, each uplink RS may be associated with a same frequency resource as an associated downlink RS (e.g., the downlink RS based on which the uplink RS is precoded), and separated from the associated downlink RS by a duration 375. For example, a frequency resource associated with the resource 360-b may be the same as a frequency resource associated with the resource 360-c.

As discussed above, the uplink RSs and the downlink RSs may be repeated over a period of frequency resources. For example, the resources 360-d and 360-f may each be used for the UE1 to transmit (e.g., TRP1 to receive) an instance of the first uplink RS, and the resources 360-e and 360-g may be used for the UE1 to transmit (e.g., TRP2 to receive) an instance of the second uplink RS. The resource 360-d may be associated with a frequency resource k (e.g., subcarrier spacing index k), counting up from a frequency resource associated with the resource 360-a, and the resource 360-e may be associated with a frequency resource k+1. The resource 360-f may then be associated with a frequency resource k+k₀ (e.g., subcarrier spacing index k+k₀), where k₀ may represent the period (e.g., interval) of frequency over which the second RSs are repeated, and the resource 360-g may be associated with a frequency resource k+k₀+1.

For the second implementation of the techniques described herein shown by the wireless communications resource diagram 350, Equations 1-8 may be adapted. For example, the instances of y₂(k) and z₂(k) may be replaced with y₂(k+1) and z₂(k+1).

Additionally, the second implementation may assume that the transmission and reception phase and gain imbalances of the UE1 are the same in frequency resources that are close to each other (e.g., adjacent frequency resources, the phase and gain imbalances are not very frequency selective). For example, Equation 8 may be altered to appear as follows:

$$\vert x ( k ) \vert = {μ}_{1} {\vert {H}_{1}^{UL} ( k ) \vert}^{2} {μ}_{2} {\vert {H}_{2}^{UL} ( k + 1 ) \vert}^{2} {\vert {ϕ}_{UE}^{T} ( k ) \vert}^{2} {\vert {ϕ}_{UE}^{R} ( k ) \vert}^{2} \qquad 9$$

where it is assumed that ϕ_{UE}^{T}(k)=ϕ_{UE}^{T}(k+1), and that ϕ_{UE}^{R}(k)=ϕ_{UE}^{R}(k+1).

The second implementation may also assume that the transmission and reception phase ramp of TRP1 and TRP2, individually or collectively, is small in frequency resources that are close to each other (e.g., adjacent frequency resources). For example, equation 2 may be altered to appear as follows:

$${φ}_{12} = {φ}_{TRP 1}^{R} + {φ}_{TRP 1}^{T} - ( {φ}_{TRP 2}^{R} + {φ}_{TRP 2}^{T} ) - 2 π ( {ρ}_{TRP 2}^{R} + {ρ}_{TRP 2}^{T} ) Δ f \qquad 10$$

where the 2π(ρ_{TRP2}^{R}+ρ_{TRP2}^{T})Δf may represent the transmission and reception phase ramp for the TRPs, and is assumed to be insignificant (e.g., small enough to cause a negligible difference). It is also noted that the channel may not be the same across the close frequency resources (e.g., the second implementation may work for very frequency-selective channels).

In some cases, the first implementation may be more accurate in estimating the timing offset and phase offset between the TRPs than the second implementation. However, the first implementation may use more resources (e.g., time resources, have a larger overhead) to estimate the offsets between the TRPs than the first implementation.

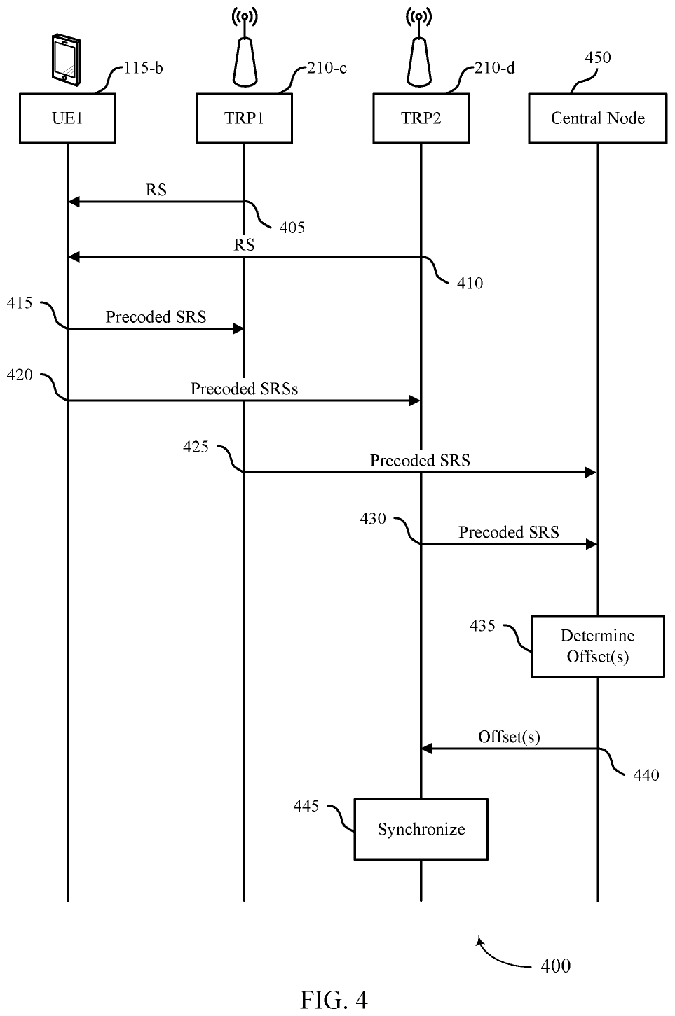

FIG. 4 shows an example of a process flow diagram 400 that supports UE-assisted time and phase synchronization for CJT in accordance with one or more aspects of the present disclosure. Aspects of the process flow diagram 400 may implement or be implemented by aspects of FIGS. 1-3. For example, the process flow diagram 400 may include a UE 115-b (e.g., UE1), a first TRP 210-c (e.g., TRP1) and a second TRP 210-d (e.g., TRP2), which may be collectively referred to as the TRPs 210, and which may be respective examples of the UEs (e.g., the UE 115-a, the UE1), the first TRP 210-a (e.g., TRP1), and the TRP 210-b (e.g., TRP2) described with reference to FIGS. 2 and 3. The UE 115-b may also be an example of the UEs 115 described with reference to FIG. 1. Likewise, the TRP 210-c and the TRP 210-d may each be an example of the network entity 105, the RU 170, the TRP, or other aspects described with reference to FIG. 1. Although certain quantities of TRPs, UEs, and other aspects are shown in the process flow diagram 400, the present disclosure may apply to any quantity of TRPs, UEs, other aspects of the process flow diagram 400, or any combination thereof.

The process flow diagram 400 may include a central node 450. In some cases, the central node 450 may be the TRP 210-c, the TRP 210-d, or both. Additionally, or alternatively, the central node 450 may be a separate entity in a wireless communications system of the TRPs and the UE 115-b. For example, the central node 450 may be a network entity, OEM entity, a network, or another entity. The process flow diagram 400 initially considers two TRPs (e.g., TRP 210-c and TRP 210-d) and one UE 115-b to assist in the synchronization between the two TRPs. The process flow diagram 400 may consider cases of a network of TRPs and a network of UEs, where the TRP 210-c and the TRP 210-d may be two TRPs of the network of TRPs, and may synchronize with other TRPs of the network of TRPs via a similar or same process as described in the process flow diagram 400, but with one or more other UEs of the network of UEs.

In the following description of the process flow diagram 400, the operations may be performed in a different order than the order shown, or other operations may be added or removed from the process flow diagram 400. For example, some operations may also be left out of process flow diagram 400, may be performed in different orders or at different times, or other operations may be added to process flow diagram 400. Although the UE 115-b, the TRP 210-c, the TRP 210-d, and the central node 450 are shown performing the operations of process flow diagram 400, some aspects of some operations may also be performed by one or more other wireless devices or network devices.

At 405 and 410, the UE 115-b may receive a first downlink RS and a second downlink RS from the TRP 210-c and the TRP 210-d, respectively. In some cases, the first downlink RS, the second downlink RS, or both, may be a channel state information (CSI) RS, a tracking reference signal (TRS), a positioning reference signal (PRS), a synchronization signal block (SSB), a demodulation reference signal (DMRS), or any combination thereof. The first downlink RS received at the UE 115-b may be called y₁, and the second downlink RS received at the UE 115-b may be called y₂.

At 415 and 420, the UE 115-b may transmit a first uplink RS and a second uplink RS to the TRP 210-c and the TRP2, respectively. As described herein, the first and second uplink RSs may be precoded based on the corresponding first and second downlink RSs. For example, the UE 115-b may receive the first downlink RS from the TRP 210-c at 405, and may precode an uplink RS (e.g., generate a precoded uplink RS) based on the first downlink RS. The precoded uplink RS may be the first uplink RS, and the UE 115-b may transmit the precoded reference signal to the TRP 210-c at 415. In some cases, the precoding of the first and second uplink RSs may reduce the impact (e.g., eliminate the impact) of the phase of the channels used to transmit the first and second uplink RSs on the uplink RSs when received by the TRPs. The first uplink RS received at the TRP 210-c may be referred to as z₁, and the second uplink RS received at the TRP 210-d may be referred to as z₂.

In some cases, the UE 115-b may receive control signaling (e.g., RRC signaling) to indicate linked pairs of resources (e.g., or resource sets) for a downlink RS and a corresponding uplink RS. For example, the UE 115-b may receive RRC signaling indicating a linked par of resources, where one of the resources of the linked pair is to be used for the first downlink RS, and the other of the resources of the linked pair is to be used for the first uplink RS. A similar linked pair of resources may be indicated for the second downlink RS and the second uplink RS. This may be for the UE 115-b to know which downlink RS to use for precoding which uplink RS (e.g., the first downlink RS for precoding the first uplink RS, and the second downlink RS for precoding the second uplink RS).

In some cases, the linked pairs of resources may be configured (e.g., indicated) as part of an uplink RS configuration. For example, a configuration for the first uplink RS, the second uplink RS, or both, may include an indication of the associated downlink RS or downlink RSs (e.g., the resources for the corresponding downlink RS or downlink RSs). Additionally, or alternatively, a path loss (PL)-RS may be used (e.g., reused) for indicating the linked pairs of resources, where the PL-RS may be configured for or by an information element (e.g., a new information element). Additionally, or alternatively, the linked pairs of resources may be configured to the UE 115-b as of a downlink RS configuration. For example, a configuration for the first downlink RS, the second downlink RS, or both, may include an indication (e.g., a pointer) pointing to a corresponding uplink RS or uplink RSs (e.g., the resources for the corresponding uplink RS or uplink RSs).

In some cases, the linked pairs of resources may be configured to the UE 115-b by an explicit configuration of the linked pairs via pointing to the IDs of the corresponding resources. For example, an explicit configuration message may point to (e.g., indicate) a resource ID or resource set ID associated with the first downlink RS and to a resource ID or resource set ID associated with the first uplink RS. A similar explicit configuration may be used for the second downlink RS and the second uplink RS in the same explicit configuration message or a different explicit configuration message.

In some cases, a first quantity of ports of the UE 115-b for receiving downlink RSs may be configured (e.g., restricted) to be the same as a second quantity of ports of the UE 115-b for transmitting uplink RSs. In some examples, the first quantity and the second quantity may be configured to be one port. In some cases, a first frequency bandwidth for the UE 115-b to receive downlink RSs may be configured to be the same as a second frequency bandwidth for the UE 115-b to transmit uplink RSs.

In some cases, a frequency spacing k₀ (e.g., a tone spacing, periodicity, frequency density) may be different among the downlink RSs and the uplink RS. For example, the UE 115-b may receive (e.g., and estimate) instances of the first downlink RS over multiple first frequency resources (e.g., a channel) spaced out by a first spacing, and may interpolate between the instances to estimate the frequency resources (e.g., channels, REs) in between the instances. The UE 115-b may then use the estimates made while receiving the instances of the first downlink RS, estimates made while interpolating, or both to transmit instances of the first uplink RS at a second frequency spacing that is the same or different than the first frequency spacing.

At 425 and 430, the central node 450 may obtain (e.g., the TRP 210-c and TRP 210-d may transmit to the central node 450) the first and second uplink RSs. As an example, if the TRP 210-c is the central node 450, the TRP 210-c may retain the first uplink RS, and the TRP 210-d may transmit the second uplink RS to the TRP 210-c. If the TRP 210-d is the central node 450, the vice versa may occur. In another example, if a separate entity is the central node 450, at 420 TRP 210-c may transmit the first uplink RS to the central node 450, and at 425 the TRP 210-d may transmit the second uplink RS to the central node 450.

At 435, the central node 450 may determine one or more of the timing offset and the phase offset (e.g., relative timing offset and relative phase offset) between the TRP 210-c and the TRP 210-d. For example, as described herein, the central node 450 may calculate a product of the first uplink RS and a conjugate of the second uplink RS as part of determining the one or more of the timing offset and the phase offset. In some cases, calculating the product as described may ensures that the transmission and reception timing and gain imbalance (e.g., timing mismatch, phase mismatch) of the UE 115-b is removed (e.g., canceled) from the determined timing offset, phase offset, or both.

By calculating the product as described herein, the only remaining timing offset, phase offset, or both may be the timing offset (e.g., relative timing offset), the phase offset (e.g., relative phase offset), or both, between the TRP 210-c and the TRP 210-d. Thus, the lack of reception and transmission calibration (e.g., transmission and reception mismatch) of the UE 115-b may not impact the determining (e.g., estimating) of the timing offset, the phase offset, or both. In some cases, the product may be calculated multiple times using multiple instances of the first and second uplink RSs transmitted via multiple frequency resources (e.g., subcarrier spacings). A more detailed description of calculating the product may be found in the description of FIG. 3.

At 440, one or more of the TRP 210-c and TRP 210-d (e.g., in this example TRP 210-d) may obtain an indication of one or more of the determined offsets (e.g., the timing offset and the phase offset) between the TRPs. In some cases (e.g., if TRP 210-d is the central node 450), the TRP 210-d may obtain the indication of the one or more of the determined offsets from itself. In other cases (e.g., if the central node 450 is the TRP 210-c or another entity), the central node 450 may transmit the one or more of the determined offsets to the TRP 210-d.

At 445, one of the TRP 210-c and the TRP 210-d (e.g., in this example TRP 210-d) may synchronize (e.g., perform a synchronization procedure) with the other of the TRP 210-c and the TRP 210-d. In some cases, the one or more determined offsets may be used in the synchronization. For example, one or both of the TRPs may adjust a clock, timer, phase, or other aspect associated with transmission or reception of the one or both of the TRPs.

In addition to the steps described in the process flow diagram 400, and at any point before, during, or after the steps described, the UE may transmit capability signaling to the TRP 210-c, the TRP 210-d, or both. The capability signaling may indicate a capability of the UE 115-b assist in the synchronization of the TRPs. For example, the capability signaling may indicate a capability of the UE 115-b to provide the first uplink RS to the TRP 210-c, the second uplink RS to the TRP 210-d, or both, to assist with the synchronization of the TRP 210-c and the TRP 210-d. Additionally, or alternatively, the capability signaling may indicate a capability of the UE 115-b to support simultaneous downlink RS reception, a capability of the UE 115-b to support simultaneous uplink RS transmission, one or more RS structures (e.g., the first example, the second example, a third example, other examples) that the UE 115-b may support, a range (e.g., a quantity of REs, a quantity of tone spacings, a threshold (e.g., maximum) range) of time and frequency resources that (e.g., over which, for which) transmission and reception characteristics of the UE 115-b may be approximately consistent (e.g., within some threshold or range of values), a quantity (e.g., threshold quantity, maximum quantity) of TRPs to which the UE 115-b may be capable of providing uplink RSs precoded based on corresponding downlink RSs, a capability of the UE 115-b to maintain a reception phase continuity and a transmission phase continuity in (e.g., over) a quantity of symbols or resources (e.g., where the first example may be associated with 2 symbols for downlink RSs and 2 symbols for uplink RSs), or any combination thereof. In some cases (e.g., if the UE 115-b is capable of simultaneous downlink RS reception but not simultaneous uplink RS transmission), a third example described herein may be used by the UE 115-b. In some cases, the range of time and frequency resources for which transmission and reception characteristics of the UE 115-b may be approximately consistent (e.g., within a range of values, based on a threshold, or the like) may determine the accuracy of techniques described herein (e.g., with respect to the second example).

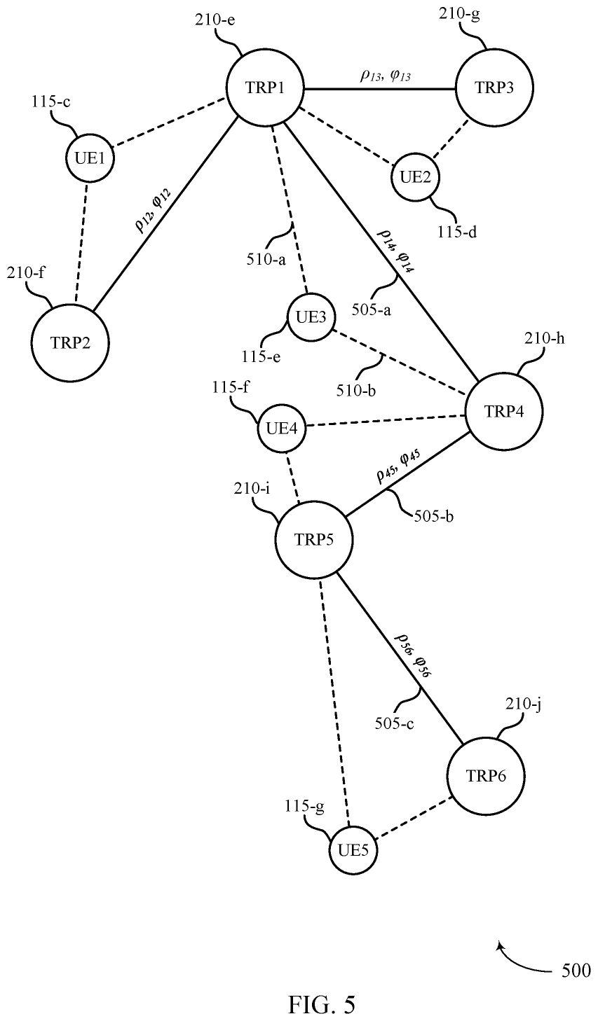

FIG. 5 shows an example of a wireless communications system 500 that supports UE-assisted time and phase synchronization for CJT in accordance with one or more aspects of the present disclosure. Aspects of the wireless communications system 500 may implement or be implemented by aspects of FIGS. 1-4. For example, the wireless communications system 500 may include a network of multiple TRPs, including a first TRP 210-e (e.g., TRP1), a second TRP 210-f (e.g., TRP2), a third TRP 210-g (e.g., TRP3), a fourth TRP 210-h (e.g., TRP4), a fifth TRP 210-i (e.g., TRP5), and a sixth TRP 210-j (e.g., TRP6), which may be collectively called the TRPs 210, and which may be examples of the network entity 105, the RU 170, the TRP, or other aspects described with reference to FIG. 1. In some examples, the TRPs 210 may be examples of the TRPs (e.g., TRP1, TRP2, TRP 210-a, TRP 210-b, TRP 210-c, TRP 210-d) described with reference to FIGS. 2-4. Additionally, the wireless communications system 500 may include multiple UEs, including a first UE 115-c (e.g., UE1), a second UE 115-d (e.g., UE2), a third UE (e.g., UE3), a fourth UE 115-f (e.g., UE4), and a fifth UE 115-g (e.g., UE5), which may be collectively called the UEs 115, and which may be examples of the UEs 115 described with reference to FIG. 1. In some examples, each of the UEs 115 may be an example of the UEs (e.g., UE1, UE 115-a, UE 115-b) described with reference to FIGS. 2-4. Although quantities of TRPs, UEs, and other aspects are shown in the wireless communications system 200, the present disclosure may apply to any quantity of TRPs, UEs, other aspects of the wireless communications system 500, or any combination thereof.

Each TRP 210 of the network of TRPs 210 may be in wireless communication with another TRP 210 via a wireless communication link 505 (e.g., a wireless communication link 505-a, a wireless communication link 505-b, and a wireless communication link 505-c). In some examples, one or more of the wireless communication links 505 may experience a corresponding timing offset, p, and a corresponding phase offset, tp. The timing offset and the phase offset for respective wireless communication links 505 may correspond to the TRPs using the wireless communication link. For example, the wireless communication link 505-a may be used by the TRP 210-e and the TRP 210-i. Thus, for example, the timing offset for the wireless communication link 505-a may be denoted as ρ₁₄, with the subscript denoting that the timing offset is relative to the TRP 210-e and the TRP 210-h.

To assist with synchronization, the pairs of the TRPs may communicate with one or more UEs via wireless communication links. For example, the TRP 210-e and the TRP 210-h may communicate with the UE 115-e via the wireless communication link 510-a and the wireless communication link 510-b. According to techniques described herein, the TRP 210-e and the TRP 210-h may synchronize timings and phases based on communications with the UE 115-e. Similarly, the TRP 210-e may synchronize with the TRP 210-f via communications with the UE 115-c, the TRP 210-e may synchronize with the TRP 210-g via communications with the UE 115-d, the TRP 210-h may synchronize with the TRP 210-i via communications with the UE 115-f, and the TRP 210-i may synchronize with the TRP 210-j via communications with the UE 115-g.

The network of TRPs may include N TRPs. In some cases, the N TRPs may be jointly synchronized (e.g., every TRP of the network of TRPs synchronized together) by obtaining a relative timing offset and a relative phase offset for at least N−1 pairs (e.g., non-identical pairs) of the network of TRPs, and if there is a path of wireless communication links 505 between each TRP to every other TRP. Two of the TRPs may be directly wirelessly connected if a UE participates in synchronization between the two TRPs, and two TRPs may be indirectly wirelessly connected if multiple wireless communication links 505 are between the two TRPs. For example, the TRP 210-e and the TRP 210-j may be indirectly wirelessly connected through a path including the wireless communication links 505-a, 505-b, and 505-c. Therefore, the TRP 210-e and the TRP 210-j may be synchronized by obtaining the relative timing offset and the relative phase offset between the TRP 210-e and the TRP 210-h, between the TRP 210-h and the TRP 210-i, and between the TRP 210-i and the TRP 210-j.

In some cases, the TRPs 210, a central node, or another entity may select the UEs 115 to participate in the synchronization of a pair of the TRPs. For example, the TRP 210-e may select the UE 115-e to participate in the synchronization between the TRP 210-e and the TRP 210-h. The selection of the UEs to participate in the synchronization may ensure that there is a path of wireless communication links 505 between each TRP of the network of TRPs.

In some cases, a pair of the TRPs may exchange RSs via OTA signaling (e.g., for example, from TRP 210-h to TRP 210-i and from TRP 210-i to TRP 210-h), and the OTA signaling may not include communications with a UE. The pair of TRPs may also jointly synchronize with the network of TRPs. Stated differently, the network of TRPs may include a mix of TRP pairs performing UE-assisted synchronization and TRP pairs performing OTA synchronization. In such cases, the TRP pair performing OTA synchronization may not precode any of the RSs communicated for the synchronization as described herein based on the TRPs of the TRP pair having a transmission and reception calibration.

To jointly synchronize the N TRPs of the network of TRPs, at least N−1 UEs may be used. To calibrate between any two TRPs, a first TRP of the two TRPs may obtain the relative timing offsets and the relative phase offsets to the second TRP of the two TRPs by summing the relative offsets (e.g., pairwise relative offsets) across the wireless communication links 505 in a path from the first TRP and the second TRP. For example, the following equations may obtain the relative timing offset and the relative phase offset between the TRP 210-e and the TRP 210-j:

$${ρ}_{16} = {ρ}_{14} + {ρ}_{45} + {ρ}_{56} \qquad 11$$

$${φ}_{16} = {φ}_{14} + {φ}_{45} + {φ}_{56} . \qquad 12$$

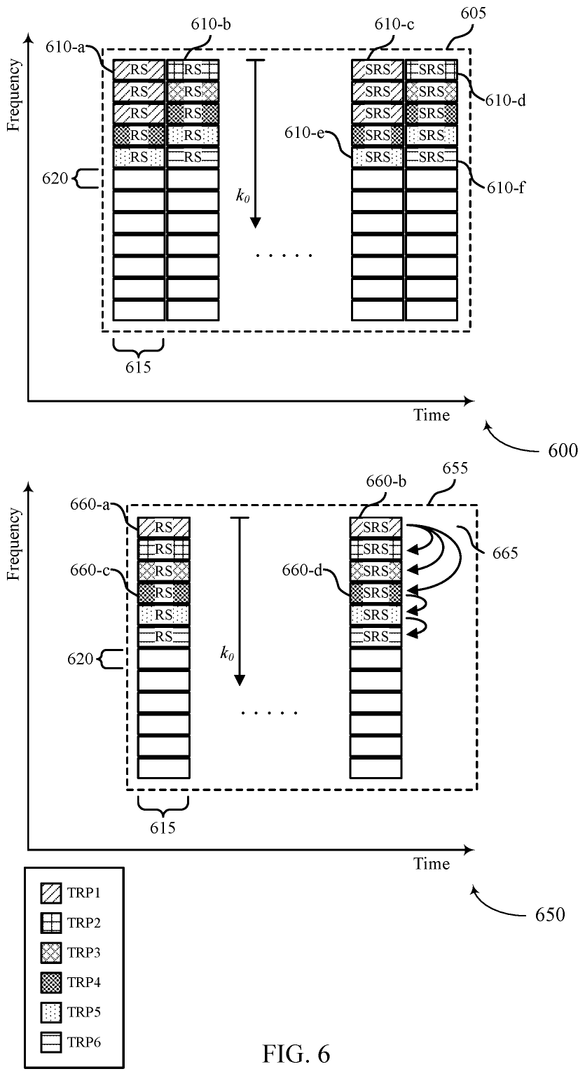

FIG. 6 shows an example of a wireless communications resource diagram 600 that supports UE-assisted time and phase synchronization for CJT in accordance with one or more aspects of the present disclosure. The wireless communications resource diagram 600 may illustrate a first example of the techniques described herein applied to the TRPs 210 described with reference to FIG. 5, and the wireless communications resource diagram 650 may illustrate a second example of the techniques described herein applied to the TRPs 210 described with reference to FIG. 5.

Aspects of the wireless communications resource diagrams 600 and 650 may implement or be implemented by aspects of FIGS. 1-5. For example, the wireless communications resource diagrams 600 and 650 may illustrate resources for wireless communications between respective TRPs (e.g., a TRP1, a TRP2, a TRP3, a TRP4, a TRP5, and a TRP6), which may collectively referred to as the TRPs, and one or more UEs (e.g., including a UE1). The TRPs may be examples of TRPs (e.g., TRP1, TRP2, TRP3, TRP4, TRP5, TRP6, TRP 210-a, TRP 210-b, TRP 210-c, TRP 210-d, TRP 210-e, TRP 210-f, TRP 210-g, and/or TRP 210-g) described with reference to FIGS. 2-5. In some aspects, one or more of the TRPs may be an example of the network entity 105, the RU 170, the TRP, or other aspects described with reference to FIG. 1. In some cases, the UE may be an example of the UEs (e.g., UE1, UE2, UE3, UE4, UE5, UE 115-a, UE 115-b, UE 115-c, UE 115-d, UE 115-f, UE 115-g) described with reference to FIGS. 2-5. In some aspects, the UE may be an example of a UE 115 described with reference to FIG. 1.

The wireless communications resource diagrams 600 and 650 may include resource depictions 605 and 655, where the columns may represent time intervals 615 (e.g., slots, symbols, a time resource) and the rows may represent frequency resources 620 (e.g., a subcarrier, bandwidths, REs, one or more frequency resources). Resources 610 and resources 660 (e.g., REs, symbols) may each correspond to a time resource and a frequency resource (e.g., time-frequency resource), and some resources 610 and 660 may be used to transmit downlink RSs, uplink RSs, or both. In some cases, RSs shown in FIG. 6 may be examples of downlink RSs, and the SRSs shown in FIG. 6 may be examples of uplink RSs. As described herein, uplink RSs and downlink RSs may comprise other types of signaling.

According to the techniques of the present disclosure and as described herein, the downlink RSs and the uplink RSs transmitted between the TRPs and the UEs may follow one or more example relationships. Based on the example relationships, the wireless communications resource diagram 600 may illustrate a first example of the techniques described herein applied to the network of TRPs, whereas the wireless communications resource diagram 650 may illustrate a second example of the techniques described herein applied to a network of TRPs. For example, the first example of the techniques described herein may follow the first example relationship and the third example relationship, and the second example of the techniques described herein may follow the first example relationship and the second example relationship. In some cases, the first example may not require the UE1 to perform simultaneous reception or simultaneous transmission, and may be more accurate than the second example. In some cases, the second example may utilize less overhead (e.g., less time resources) and be less accurate than the first example, and may be associated with or lead to the UE1 to performing simultaneous transmission and simultaneous reception.

In the wireless communications resource diagrams 600 and 650, a pattern of resource allocations for RSs repeats every k₀ frequency resources. For N TRPs in the network of TRPs, the first example (e.g., illustrated in the wireless communications resource diagram 600) may have a resource use (e.g., overhead) per pattern of (N−1) frequency resources (e.g., REs) over two time resources (e.g., symbols, slots) for downlink RSs, and (N−1) frequency resources over two time resources for uplink RSs. For N TRPs in the network of TRPs, the second example (e.g., illustrated in the wireless communications resource diagram 650) may have a resource use per pattern of N frequency resources over one time resource for downlink RSs, and N frequency resources over one time resource for uplink RSs.

Accordingly, the first example may experience higher resource use than the second example, but may be more accurate than the second example due to following the first example relationship and the third example relationship. The first example may also be less complex than the second example for the UEs participating in the synchronization. For example, the first embodiment does not utilize simultaneous downlink RS reception or simultaneous uplink RS transmission. On the other hand, the second example may experience lower resource use than the first example (e.g., almost half), but may be less accurate than the first example due to following the first example relationship and the second example relationship. Additionally, the second example may be more complex than the first example for the UEs participating in the synchronization. For example, the second example may utilize simultaneous downlink RS reception and simultaneous uplink RS transmission.

As described with reference to FIG. 3, the uplink RSs (e.g., SRSs) of the wireless communications resource diagrams 600 and 650 may be precoded based on a corresponding downlink RS (e.g., RS). For example, an uplink RS transmitted in the resource 610-c to the TRP1 may be precoded based on a corresponding downlink RS received in resource 610-a from the TRP1, and an uplink RS transmitted in resource 610-d or resource 610-e to the TRP2 may be precoded based on a corresponding downlink RS received from TRP2 in resource 610-b. Similarly, an uplink RS transmitted to the TRP3 in resource 660-d may be precoded based on a corresponding downlink RS received from the TRP3 in resource 660-c.

In the wireless communications resource diagram 600, two TRPs receiving two uplink RSs in a same frequency resource may obtain the relative offsets between the two TRPs based on the two uplink RSs. For example, because TRP5 receives a first downlink RS in resource 610-c via the same frequency resource as TRP6 receives a second downlink RS in resource 610-f, the TRP5 and the TRP6 may obtain the relative timing offset and the relative phase offset between the TRP5 and the TRP6 based on the first downlink RS and the second downlink RS.

In the wireless communications resource diagram 650, the curved arrows 665 may indicate two uplink RSs that are transmitted by a same UE. Thus, the two TRPs that receive the two uplink RSs indicated by a curved arrow 665 may obtain the relative offsets between the two TRPs based on the two uplink RSs. For example, a first UE may transmit a first uplink RS associated with resource 660-b to the TRP1 and transmit a second uplink RS associated with resource 660-d to the TRP4. Accordingly, the TRP1 and the TRP4 may use the first uplink RS and the second uplink RS to obtain the relative offsets between the TRP1 and the TRP4.

As described herein, the relative offsets between a first TRP and a second TRP may be obtained by multiplying a first uplink RS received at the first TRP by the conjugate of a second uplink RS received at the second TRP, where the first uplink RS and the second uplink RS are precoded and transmitted by the same UE. The precoding done by the UE on the first uplink RS and the second uplink RS may be performed based on a first downlink RS and a second downlink RS received at the UE from the first TRP and the second TRP, respectively.

In the wireless communications resource diagram 650, and referring to FIG. 5, multiple UEs of the network of UEs may transmit uplink RSs during a resource 660. Additionally, or alternatively, a TRP of the network of TRPs may transmit more than one signal during a resource 660. For example, in the resource 660-a, the TRP1 may transmit a downlink RS to the UE1, the UE2, and the UE3. This may be accomplished through broadcasting techniques, beamforming techniques, or MU-MIMO techniques. According, the UE1, the UE2, and the UE3 may each transmit an uplink RS to the TRP1 in the resource 660-b.

In some cases, multiple uplink RSs transmitted by multiple UEs in a same resource (e.g., time and frequency resource, symbol, slot) may be differentiable (e.g., orthogonalized) in a cyclic shift domain. For example, each UE transmitting an uplink RSs during the same resource may select (e.g., randomly select) a cyclic shift to be associated with the corresponding uplink RS out of a plurality (e.g., 64) of cyclic shifts, where the TRP may differentiate the uplink RSs based on the associated cyclic shifts. The TRP may differentiate the uplink RSs received during the same resource while the quantity of UEs transmitting the uplink RSs does not exceed a threshold quantity (e.g., maximum quantity) of cyclic shifts. Accordingly, if the degree of a TRP corresponds to a quantity of UEs directly wirelessly connected to the TRP and assisting in synchronization with another TRP, the degree of each TRP in the network of TRP may be maintained below the threshold quantity of cyclic shifts.

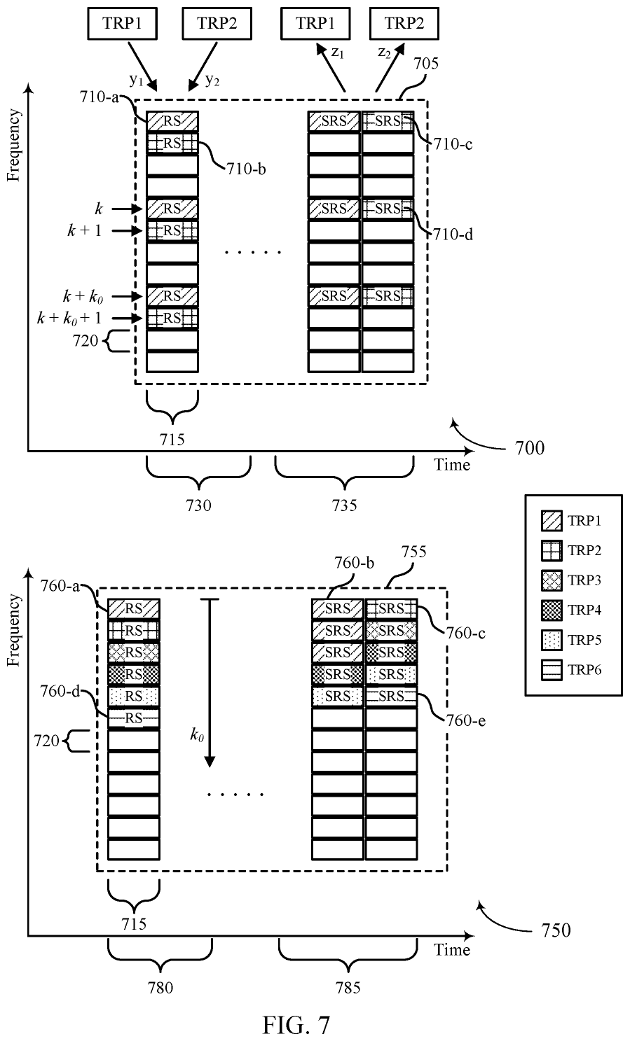

FIG. 7 shows an example of a wireless communications resource diagram 700 that supports UE-assisted time and phase synchronization for CJT in accordance with one or more aspects of the present disclosure. The wireless communications resource diagram 700 may illustrate a third possible example of the techniques described herein applied to two TRPs, such as with reference to FIGS. 2 and 3, and the wireless communications resource diagram 750 may illustrate the third example of the techniques described herein applied to a network of TRPs, such as with reference to of FIGS. 5 and 6.

Aspects of the wireless communications resource diagrams 700 and 750 may implement or be implemented by aspects of FIGS. 1-6. For example, the wireless communications resource diagrams 700 and 750 may illustrate resources for wireless communications between TRPs (e.g., a TRP1, a TRP2, a TRP3, a TRP4, a TRP5, and a TRP6), which may collectively referred to as the TRPs, and one or more UEs (e.g., including a UE1). The TRPs may be examples of TRPs (e.g., TRP1, TRP2, TRP3, TRP4, TRP5, TRP6, TRP 210-a, TRP 210-b, TRP 210-c, TRP 210-d, TRP 210-e, TRP 210-f, TRP 210-g, and/or TRP 210-g) described with reference to FIGS. 2-5. In some aspects, one or more of the TRPs may be an example of the network entity 105, the RU 170, the TRP, or other aspects described with reference to FIG. 1. In some cases, the UE may be an example of the UEs (e.g., UE1, UE2, UE3, UE4, UE5, UE 115-a, UE 115-b, UE 115-c, UE 115-d, UE 115-f, UE 115-g) described with reference to FIGS. 2-5. In some aspects, the UE may be an example of a UE 115 described with reference to FIG. 1. Additionally, FIG. 7 may show downlink RSs y₁ and y₂, which may be examples of the first downlink RS y₁ and the second downlink RS y₂ as described with respect to FIG. 3, as well as uplink RSs z₁ and z₂, which may be examples of the first uplink RS z₁ and the second uplink RS z₂ as described with respect to FIG. 3.

The wireless communications resource diagrams 700 and 750 may include resource depictions 705 and 755, where the columns may represent time intervals 715 (e.g., slots, symbols, a time resource) and the rows may represent frequency resources 720 (e.g., a subcarrier, a bandwidth, REs, one or more frequency resources). Resources 710 (e.g., resource elements, symbols, resource 710-a, resource 710-b, resource 710-c, and resource 710-d) and resources 760 (e.g., resource elements, symbols, resource 760-a, resource 760-b, resource 760-c, resource 760-d, and resource 760-e) may each correspond to a time resource and a frequency resource (e.g., time-frequency resource), and some of the resources 710 and 760 may be used to transmit downlink RSs, uplink RSs, or both. In some cases, the RSs shown in FIG. 7 may be examples of downlink RSs, and the SRSs shown in FIG. 7 may be examples of uplink RSs. As described herein, uplink RSs and downlink RSs may comprise other types of signaling as well.

The third example illustrated by the wireless communications resource diagrams 700 and 750 may, at least in some aspects, be a mix (e.g., hybrid) of the first example and the second example. In the third example, the one or more U.S. assisting the TRPs in synchronizing may support simultaneous downlink RS reception, but may not support simultaneous uplink RS transmission. For example, as simultaneous uplink transmissions may affect an uplink link budget pf the one or more UEs, the one or more UEs may not support simultaneous uplink transmissions.

For example, the resource depictions 705 and 755 corresponding to the third example may include a receiving section (e.g., a receiving section 730, a receiving section 780) including resources 710 and 760 used for the one or more UEs to receive downlink RSs from the TRPs, and a transmitting section (e.g., transmitting section 735, a transmitting section 785) including resources 710 and 760 used for the one or more UEs to transmit uplink RSs to the TRPs.

In some aspects, the receiving sections 730 and 780 of the third embodiment may function similarly to how the one or more UEs received the downlink RSs in the second example, and the transmitting section 735 and 785 of the third example may function similarly to how the one or more UEs transmitted the uplink RSs in the first example. For example, in the receiving section 730 and 780, the one or more UEs may receive downlink RSs from the TRPs during a same time resource and via frequency resources that are close to each other (e.g., adjacent, within a threshold frequency difference). In the transmitting section 735 and 785, however, a UE may transmit the uplink RSs corresponding to two synchronizing TRPs via a same frequency resource and during two time resources that are close to each other (e.g., adjacent, within a threshold time difference). A more detailed description of the different resource allocations for transmitting and receiving uplink RSs and downlink RSs may be found in the descriptions of FIGS. 3 and 6.

The resource depictions 705 and 755 may illustrate different UEs transmitting uplink RSs via different time resources and frequency resources. However, it is noted that, as described herein, multiple uplink RSs may be transmitted by multiple UEs during a same time resource and via a same frequency resource (e.g., multiplexed) by differentiating the multiple uplink RSs in the cyclic shift domain.

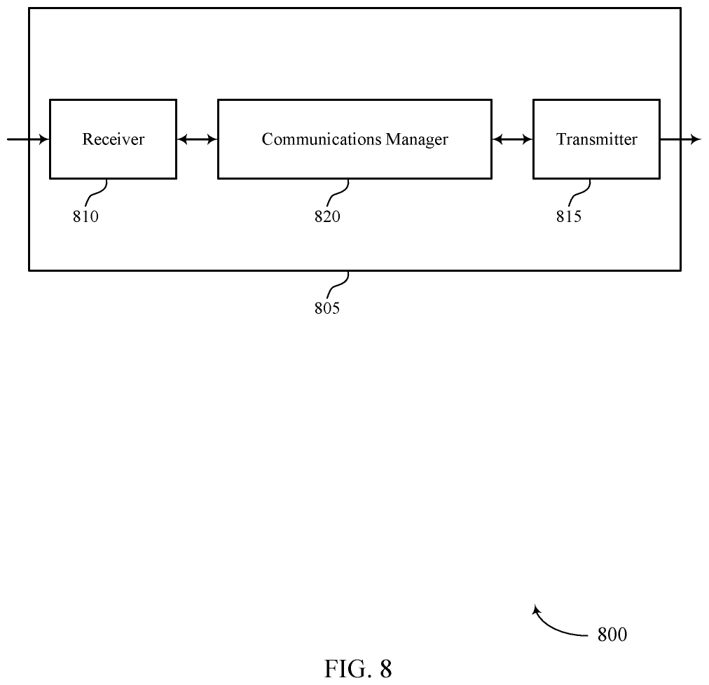

FIG. 8 shows a block diagram 800 of a device 805 that supports UE-assisted time and phase synchronization for CJT in accordance with one or more aspects of the present disclosure. The device 805 may be an example of aspects of an TRP as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of UE-assisted time and phase synchronization for CJT as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. For example, the communications manager 820 is capable of, configured to, or operable to support a means for transmitting, to a first UE, a first downlink RS via a first set of resources. The communications manager 820 is capable of, configured to, or operable to support a means for receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for more efficient utilization of communication resources. For example, techniques described herein may allow for more reliably synchronized TRPs, leading to less errors in communications and less retransmissions of signaling. Thus, more reliable communication via improved synchronization between TRPs, according to the techniques described herein, may allow for more efficient utilization of communication resources.

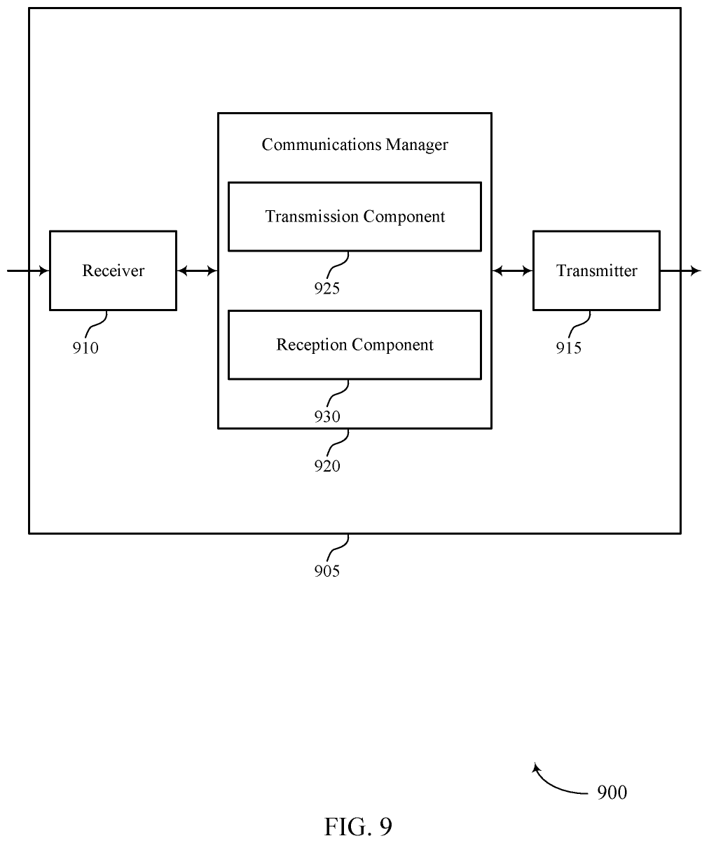

FIG. 9 shows a block diagram 900 of a device 905 that supports UE-assisted time and phase synchronization for CJT in accordance with one or more aspects of the present disclosure. The device 905 may be an example of aspects of a device 805 or an TRP 115 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of UE-assisted time and phase synchronization for CJT as described herein. For example, the communications manager 920 may include a transmission component 925 a reception component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. The transmission component 925 is capable of, configured to, or operable to support a means for transmitting, to a first UE, a first downlink RS via a first set of resources. The reception component 930 is capable of, configured to, or operable to support a means for receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

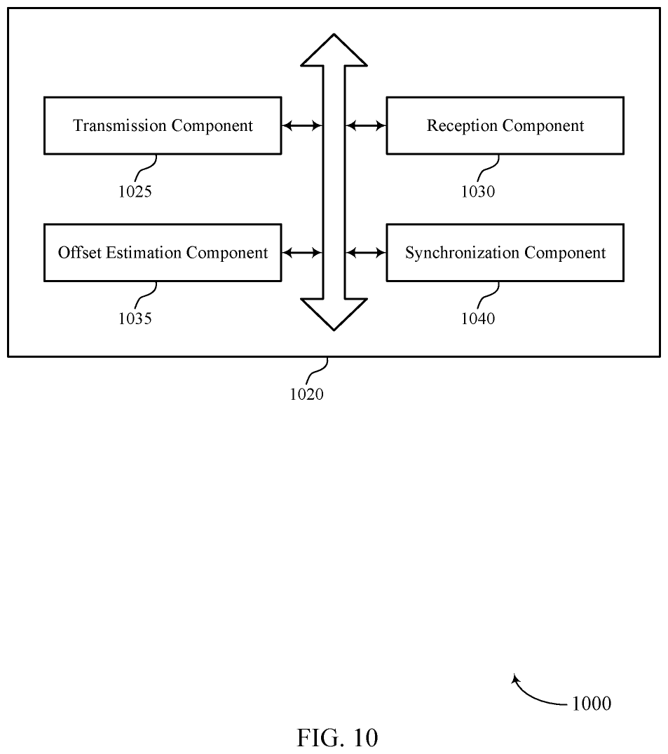

FIG. 10 shows a block diagram 1000 of a communications manager 1020 that supports UE-assisted time and phase synchronization for CJT in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of UE-assisted time and phase synchronization for CJT as described herein. For example, the communications manager 1020 may include a transmission component 1025, a reception component 1030, an offset estimation component 1035, a synchronization component 1040, or any combination thereof. Each of these components, or components or subcomponents thereof (e.g., one or more processors, one or more memories), may communicate, directly or indirectly, with one another (e.g., via one or more buses).

The communications manager 1020 may support wireless communication in accordance with examples as disclosed herein. The transmission component 1025 is capable of, configured to, or operable to support a means for transmitting, to a first UE, a first downlink RS via a first set of resources. The reception component 1030 is capable of, configured to, or operable to support a means for receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

In some examples, the reception component 1030 is capable of, configured to, or operable to support a means for receiving, from the second TRP, a message indicating the second precoded uplink RS. In some examples, the offset estimation component 1035 is capable of, configured to, or operable to support a means for estimating the phase offset, the timing offset, or both, based on a product of the first precoded uplink RS and a conjugate of the second precoded uplink RS.

In some examples, the estimation of the phase offset, the timing offset, or both is based on a computation of the product of the first precoded uplink RS and the conjugate of the second precoded uplink RS for a set of multiple subcarriers.

In some examples, the transmission component 1025 is capable of, configured to, or operable to support a means for outputting, to a central node, a first message indicating the first precoded uplink RS. In some examples, the offset estimation component 1035 is capable of, configured to, or operable to support a means for obtaining a second message indicating an estimation of the phase offset, the timing offset, or both, from the central node in response to the first message, where the estimation of the phase offset, the timing offset, or both are based on a product of the first precoded uplink RS and a conjugate of the second precoded uplink RS.

In some examples, the estimation of the phase offset, the timing offset, or both is based on a computation of the product of the first precoded uplink RS and the conjugate of the second precoded uplink RS for a set of multiple subcarriers. In some examples, the central node includes one of the second TRP or another network entity.

In some examples, the second precoded uplink RS is associated with a second downlink RS that corresponds to a third set of resources, and the offset estimation component 1035 is capable of, configured to, or operable to support a means for obtaining the phase offset, the timing offset, or both based on a product of the first precoded uplink RS and a conjugate of the second precoded uplink RS, and further based on a subcarrier spacing index associated with the first set of resources, the second set of resources, the third set of resources, the fourth set of resources, or any combination thereof.

In some examples, a frequency resource of the first set of resources has a same frequency as a corresponding frequency resource of the third set of resources, or a frequency resource of the second set of resources has a same frequency as a corresponding frequency resource of the fourth set of resources, or both.

In some examples, a time resource of the first set of resources is the same as a corresponding time resource of the third set of resources, or a time resource of the second set of resources is the same as a corresponding time resource of the fourth set of resources, or both. In some examples, a time resource of the first set of resources is the same as a corresponding time resource of the third set of resources and a frequency resource of the second set of resources has a same frequency as a corresponding frequency resource of the fourth set of resources.

In some examples, the offset estimation component 1035 is capable of, configured to, or operable to support a means for determining a threshold timing offset associated with synchronization based on a frequency spacing between the first set of resources, the second set of resources, the third set of resources, the fourth set of resources, or a combination thereof. In some examples, the offset estimation component 1035 is capable of, configured to, or operable to support a means for determining a threshold offset resolution based on a bandwidth for the first precoded uplink RS, the second precoded uplink RS, the first downlink RS, the second downlink RS, or any combination thereof.

In some examples, the synchronization component 1040 is capable of, configured to, or operable to support a means for synchronizing a timing or a phase, or both, with a third TRP based on a second phase offset, a second timing offset, or both, between the second TRP and a third TRP, where the first TRP synchronizes with the third TRP using a combination of the phase offset and the second phase offset, a combination of the timing offset and the second timing offset, or both. In some examples, the second phase offset, the second timing offset, or both, are based on a third precoded uplink RS transmitted from a second UE to the second TRP and a fourth precoded uplink RS transmitted from the second UE to the third TRP.

In some examples, the transmission component 1025 is capable of, configured to, or operable to support a means for transmitting, to the first UE, a control message including an indication that the first set of resources for the first downlink RS are associated with the second set of resources for the first precoded uplink RS.

In some examples, the reception component 1030 is capable of, configured to, or operable to support a means for receiving capability signaling indicating a capability of the first UE to provide the first precoded uplink RS to the first TRP to assist with synchronization of the first TRP and the second TRP.

In some examples, the capability signaling indicates a capability of the first UE to support simultaneous downlink RS reception, a capability of the first UE to support simultaneous uplink RS transmission, one or more reference signal structures the first UE supports, a range of time and frequency resources for which transmission and reception characteristics of the first UE are approximately consistent (e.g., the characteristic vary within some range of values or parameters), a threshold (e.g., maximum) quantity of TRPs to which the first UE is capable of providing precoded uplink RSs, a capability of the first UE to maintain reception phase continuity and transmission phase continuity in a quantity of symbols, or any combination thereof. In some examples, the first downlink RS includes one of a tracking reference signal, a positioning reference signal, a synchronization signal block, or a demodulation reference signal.

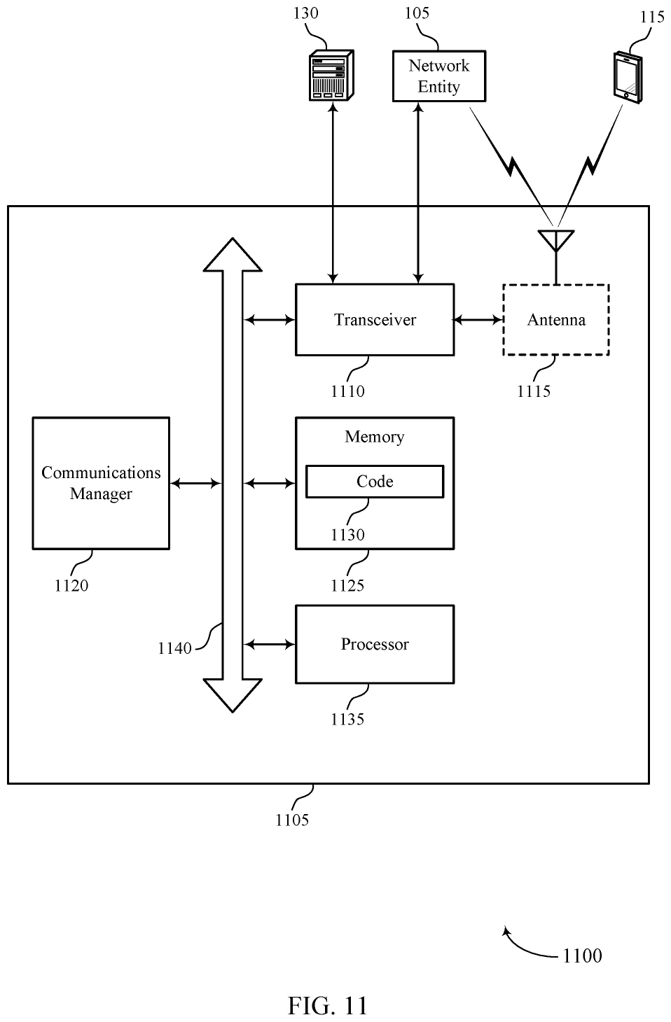

FIG. 11 shows a diagram of a system 1100 including a device 1105 that supports UE-assisted time and phase synchronization for CJT in accordance with one or more aspects of the present disclosure. The device 1105 may be an example of or include the components of a device 805, a device 905, or an TRP as described herein. The device 1105 may include components for bi-directional voice and data communications including components for transmitting and receiving communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting UE-assisted time and phase synchronization for CJT). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. As such, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication in accordance with examples as disclosed herein. For example, the communications manager 1120 is capable of, configured to, or operable to support a means for transmitting, to a first UE, a first downlink RS via a first set of resources. The communications manager 1120 is capable of, configured to, or operable to support a means for receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP.

By including or configuring the communications manager 1120 in accordance with examples as described herein, the device 1105 may support techniques for improved communications reliability. For example, the techniques described herein may allow for more reliably synchronized TRPs. More reliable synchronization may reduce the quantity of messaged transmitted or received in error. Thus, the techniques described herein may allow for improved communications reliability.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of UE-assisted time and phase synchronization for CJT as described herein, or the at least one processor 1135 and the at least one memory 1125 may be otherwise configured to, individually or collectively, perform or support such operations.

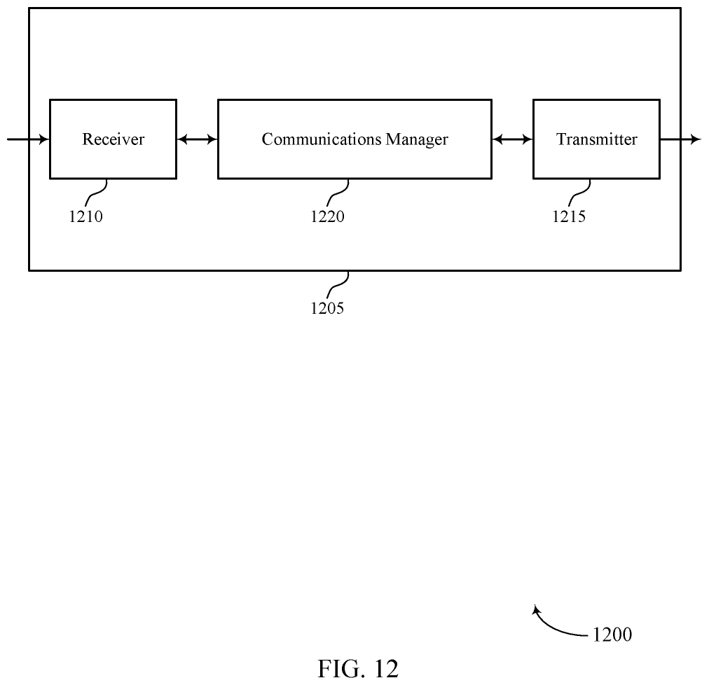

FIG. 12 shows a block diagram 1200 of a device 1205 that supports UE-assisted time and phase synchronization for CJT in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to UE-assisted time and phase synchronization for CJT). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to UE-assisted time and phase synchronization for CJT). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of UE-assisted time and phase synchronization for CJT as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor. If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. For example, the communications manager 1220 is capable of, configured to, or operable to support a means for receiving, from a first TRP, a first downlink RS via a first set of resources. The communications manager 1220 is capable of, configured to, or operable to support a means for transmitting, to the first TRP, a first precoded uplink RS via a second set of resources that is associated with the first set of resources, where the first precoded uplink RS is precoded based on an estimation of the first downlink RS. The communications manager 1220 is capable of, configured to, or operable to support a means for receiving, from a second TRP, a second downlink RS via a third set of resources. The communications manager 1220 is capable of, configured to, or operable to support a means for transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for more efficient utilization of communication resources. For example, techniques described herein may allow for more reliably synchronized TRPs, leading to less errors in communications and less retransmissions of signaling. Thus, more reliable communication via improved synchronization between TRPs, according to the techniques described herein, may allow for more efficient utilization of communication resources.

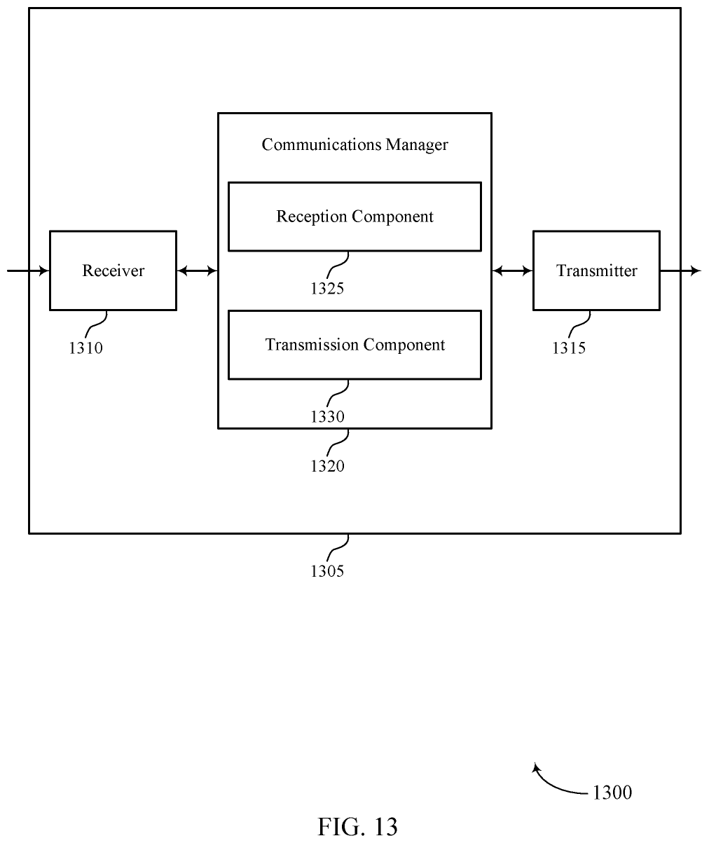

FIG. 13 shows a block diagram 1300 of a device 1305 that supports UE-assisted time and phase synchronization for CJT in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, and the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to UE-assisted time and phase synchronization for CJT). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to UE-assisted time and phase synchronization for CJT). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of UE-assisted time and phase synchronization for CJT as described herein. For example, the communications manager 1320 may include a reception component 1325 a transmission component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication in accordance with examples as disclosed herein. The reception component 1325 is capable of, configured to, or operable to support a means for receiving, from a first TRP, a first downlink RS via a first set of resources. The transmission component 1330 is capable of, configured to, or operable to support a means for transmitting, to the first TRP, a first precoded uplink RS via a second set of resources that is associated with the first set of resources, where the first precoded uplink RS is precoded based on an estimation of the first downlink RS. The reception component 1325 is capable of, configured to, or operable to support a means for receiving, from a second TRP, a second downlink RS via a third set of resources. The transmission component 1330 is capable of, configured to, or operable to support a means for transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

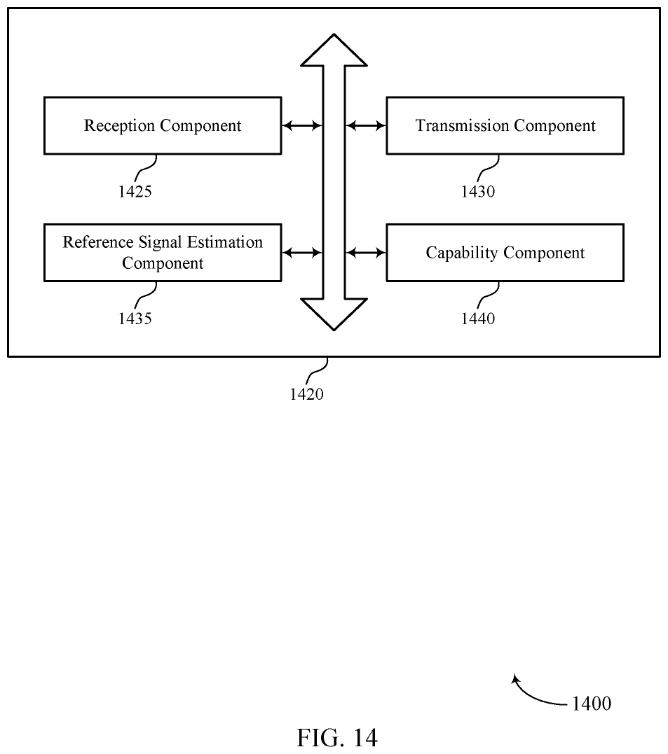

FIG. 14 shows a block diagram 1400 of a communications manager 1420 that supports UE-assisted time and phase synchronization for CJT in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of UE-assisted time and phase synchronization for CJT as described herein. For example, the communications manager 1420 may include a reception component 1425, a transmission component 1430, a reference signal estimation component 1435, a capability component 1440, or any combination thereof. Each of these components, or components or subcomponents thereof (e.g., one or more processors, one or more memories), may communicate, directly or indirectly, with one another (e.g., via one or more buses).

The communications manager 1420 may support wireless communication in accordance with examples as disclosed herein. The reception component 1425 is capable of, configured to, or operable to support a means for receiving, from a first TRP, a first downlink RS via a first set of resources. The transmission component 1430 is capable of, configured to, or operable to support a means for transmitting, to the first TRP, a first precoded uplink RS via a second set of resources that is associated with the first set of resources, where the first precoded uplink RS is precoded based on an estimation of the first downlink RS. In some examples, the reception component 1425 is capable of, configured to, or operable to support a means for receiving, from a second TRP, a second downlink RS via a third set of resources. In some examples, the transmission component 1430 is capable of, configured to, or operable to support a means for transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

In some examples, a frequency resource of the first set of resources has a same frequency as a corresponding frequency resource of the third set of resources, a frequency resource of the second set of resources has a same frequency as a corresponding frequency resource of the fourth set of resources, or both.

In some examples, a time resource of the first set of resources is the same as a corresponding time resource of the third set of resources, a time resource of the second set of resources is the same as a corresponding time resource of the fourth set of resources, or both. In some examples, a time resource of the first set of resources is the same as a corresponding time resource of the third set of resources, and the frequency resource of the second set of resources has a same frequency as a corresponding frequency resource of the fourth set of resources.

In some examples, the reception component 1425 is capable of, configured to, or operable to support a means for receiving a control message including an indication that the first set of resources for the first downlink RS are associated with the second set of resources for the first precoded uplink RS.

In some examples, the reception component 1425 is capable of, configured to, or operable to support a means for receiving control signaling including a first indication that the first set of resources for the first downlink RS are associated with the second set of resources for the first precoded uplink RS, and a second indication that the third set of resources for the second downlink RS are associated with the fourth set of resources for the second precoded uplink RS. In some examples, the control signaling includes one or more uplink RS configurations, one or more downlink reference configurations, one or more pointers associated with uplink RS resource identifiers or downlink RS identifiers, or any combination thereof.

In some examples, the first downlink reference signal, and the reference signal estimation component 1435 is capable of, configured to, or operable to support a means for interpolating between the respective frequency spacings of the multiple instances of the first downlink RS and between the respective frequency spacings of the multiple instances of the second downlink RS, where the estimation of the first downlink RS and the estimation of the second downlink RS is based on the interpolating.

In some examples, the capability component 1440 is capable of, configured to, or operable to support a means for transmitting capability signaling indicating a capability of the first UE to provide the first precoded uplink RS to the first TRP to assist with synchronization of the first TRP and the second TRP.

In some examples, the capability signaling indicates a capability of the first UE to support simultaneous downlink RS reception, a capability of the first UE to support simultaneous uplink RS transmission, one or more reference signal structures the first UE supports, a range of time and frequency resources for which transmission and reception characteristics of the first UE are approximately consistent, a threshold (e.g., maximum) quantity of TRPs to which the first UE is capable of providing precoded uplink RSs, a capability of the first UE to maintain reception phase continuity and transmission phase continuity in a quantity of symbols, or any combination thereof.

In some examples, the reception component 1425 is capable of, configured to, or operable to support a means for receiving, from a third TRP, a third downlink RS via a fifth set of resources. In some examples, the transmission component 1430 is capable of, configured to, or operable to support a means for transmitting, to the third TRP, a third precoded uplink RS via a sixth set of resources that is associated with the fifth set of resources, where the third precoded uplink RS is precoded based on an estimation of the third downlink RS.

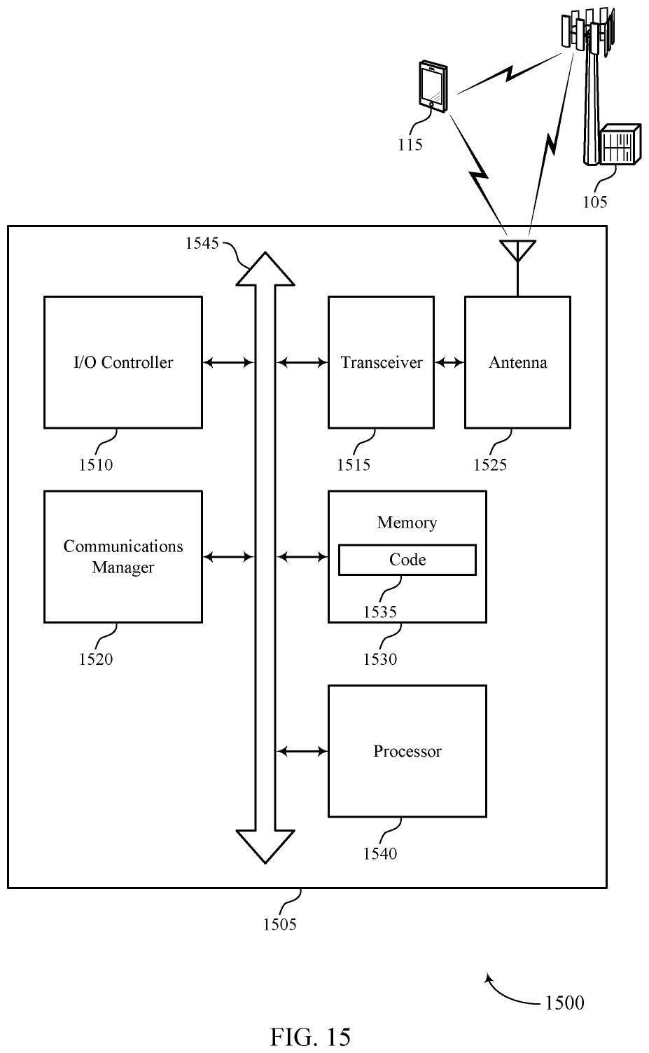

FIG. 15 shows a diagram of a system 1500 including a device 1505 that supports UE-assisted time and phase synchronization for CJT in accordance with one or more aspects of the present disclosure. The device 1505 may be an example of or include the components of a device 1205, a device 1305, or a UE 115 as described herein. The device 1505 may communicate (e.g., wirelessly) with one or more network entities 105, one or more UEs 115, or any combination thereof. The device 1505 may include components for bi-directional voice and data communications including components for transmitting and receiving communications, such as a communications manager 1520, an input/output (I/O) controller 1510, a transceiver 1515, an antenna 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna 1525. However, in some other cases, the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable code 1535 including instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may contain, among other things, a basic I/O system (BIOS) which may control basic hardware or software operation such as the interaction with peripheral components or devices.

The at least one processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting UE-assisted time and phase synchronization for CJT). For example, the device 1505 or a component of the device 1505 may include at least one processor 1540 and at least one memory 1530 coupled with or to the at least one processor 1540, the at least one processor 1540 and at least one memory 1530 configured to perform various functions described herein. In some examples, the at least one processor 1540 may include multiple processors and the at least one memory 1530 may include multiple memories. One or more of the multiple processors may be coupled with one or more of the multiple memories, which may, individually or collectively, be configured to perform various functions herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. As such, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code stored in the at least one memory 1530 or otherwise, to perform one or more of the functions described herein.

The communications manager 1520 may support wireless communication in accordance with examples as disclosed herein. For example, the communications manager 1520 is capable of, configured to, or operable to support a means for receiving, from a first TRP, a first downlink RS via a first set of resources. The communications manager 1520 is capable of, configured to, or operable to support a means for transmitting, to the first TRP, a first precoded uplink RS via a second set of resources that is associated with the first set of resources, where the first precoded uplink RS is precoded based on an estimation of the first downlink RS. The communications manager 1520 is capable of, configured to, or operable to support a means for receiving, from a second TRP, a second downlink RS via a third set of resources. The communications manager 1520 is capable of, configured to, or operable to support a means for transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP.

By including or configuring the communications manager 1520 in accordance with examples as described herein, the device 1505 may support techniques for improved communications reliability via communicating with TRPs that are more reliably synchronized. For example, the techniques described herein may allow for the TRPs to synchronize in conditions previously unsuitable for synchronization (e.g., low quality wireless communication link, NLOS channel). However, the techniques described herein may allow for the TRPs to synchronize via the UEs, providing more reliable communications to the UEs.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of UE-assisted time and phase synchronization for CJT as described herein, or the at least one processor 1540 and the at least one memory 1530 may be otherwise configured to, individually or collectively, perform or support such operations.

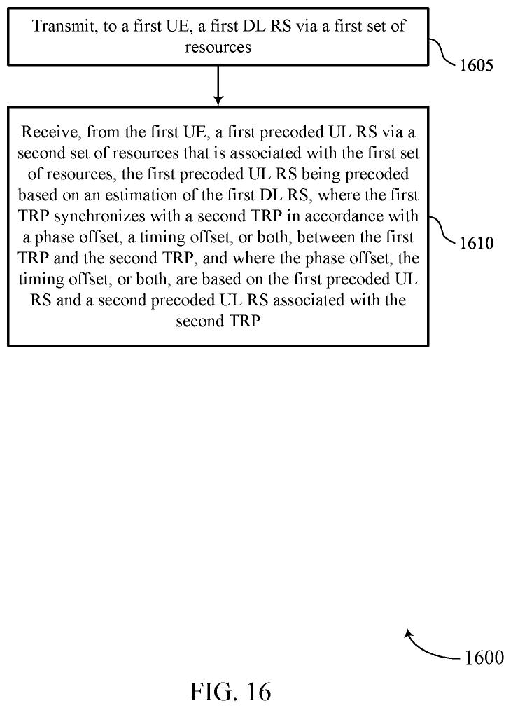

FIG. 16 shows a flowchart illustrating a method 1600 that supports UE-assisted time and phase synchronization for CJT in accordance with aspects of the present disclosure. The operations of the method 1600 may be implemented by an TRP or its components as described herein. For example, the operations of the method 1600 may be performed by an TRP as described with reference to FIGS. 1 through 11. In some examples, an TRP may execute a set of instructions to control the functional elements of the TRP to perform the described functions. Additionally, or alternatively, the TRP may perform aspects of the described functions using special-purpose hardware.

At 1605, the method may include transmitting, to a first UE, a first downlink RS via a first set of resources. The operations of 1605 may be performed in accordance with examples as disclosed herein. In some examples, aspects of the operations of 1605 may be performed by a transmission component 1025 as described with reference to FIG. 10.

At 1610, the method may include receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP. The operations of 1610 may be performed in accordance with examples as disclosed herein. In some examples, aspects of the operations of 1610 may be performed by a reception component 1030 as described with reference to FIG. 10.

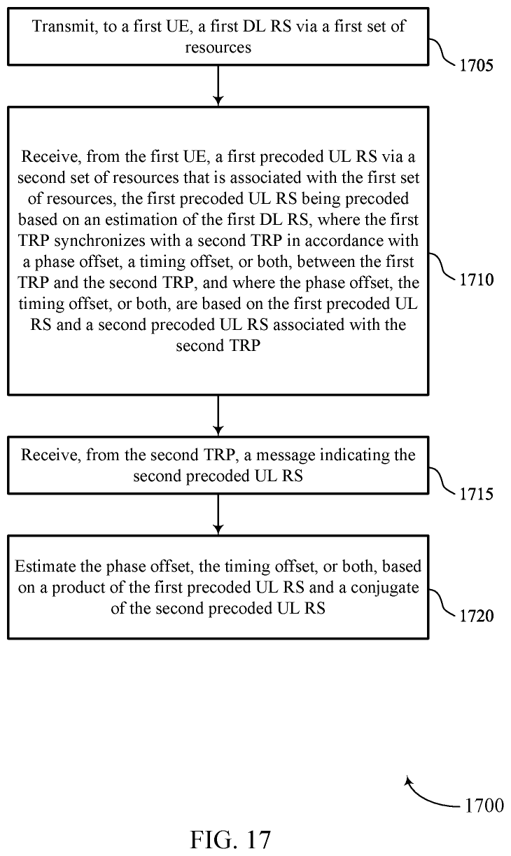

FIG. 17 shows a flowchart illustrating a method 1700 that supports UE-assisted time and phase synchronization for CJT in accordance with aspects of the present disclosure. The operations of the method 1700 may be implemented by an TRP or its components as described herein. For example, the operations of the method 1700 may be performed by an TRP as described with reference to FIGS. 1 through 11. In some examples, an TRP may execute a set of instructions to control the functional elements of the TRP to perform the described functions. Additionally, or alternatively, the TRP may perform aspects of the described functions using special-purpose hardware.

At 1705, the method may include transmitting, to a first UE, a first downlink RS via a first set of resources. The operations of 1705 may be performed in accordance with examples as disclosed herein. In some examples, aspects of the operations of 1705 may be performed by a transmission component 1025 as described with reference to FIG. 10.

At 1710, the method may include receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP. The operations of 1710 may be performed in accordance with examples as disclosed herein. In some examples, aspects of the operations of 1710 may be performed by a reception component 1030 as described with reference to FIG. 10.

At 1715, the method may include receiving, from the second TRP, a message indicating the second precoded uplink RS. The operations of 1715 may be performed in accordance with examples as disclosed herein. In some examples, aspects of the operations of 1715 may be performed by a reception component 1030 as described with reference to FIG. 10.

At 1720, the method may include estimating the phase offset, the timing offset, or both, based on a product of the first precoded uplink RS and a conjugate of the second precoded uplink RS. The operations of 1720 may be performed in accordance with examples as disclosed herein. In some examples, aspects of the operations of 1720 may be performed by an offset estimation component 1035 as described with reference to FIG. 10.

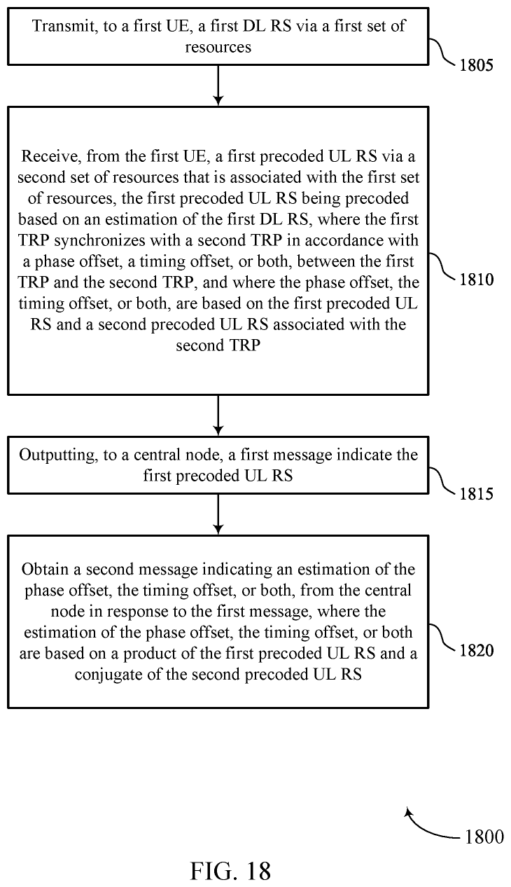

FIG. 18 shows a flowchart illustrating a method 1800 that supports UE-assisted time and phase synchronization for CJT in accordance with aspects of the present disclosure. The operations of the method 1800 may be implemented by an TRP or its components as described herein. For example, the operations of the method 1800 may be performed by an TRP as described with reference to FIGS. 1 through 11. In some examples, an TRP may execute a set of instructions to control the functional elements of the TRP to perform the described functions. Additionally, or alternatively, the TRP may perform aspects of the described functions using special-purpose hardware.

At 1805, the method may include transmitting, to a first UE, a first downlink RS via a first set of resources. The operations of 1805 may be performed in accordance with examples as disclosed herein. In some examples, aspects of the operations of 1805 may be performed by a transmission component 1025 as described with reference to FIG. 10.

At 1810, the method may include receiving, from the first UE, a first precoded uplink RS via a second set of resources that is associated with the first set of resources, the first precoded uplink RS being precoded based on an estimation of the first downlink RS, where the first TRP synchronizes with a second TRP in accordance with a phase offset, a timing offset, or both, between the first TRP and the second TRP, and where the phase offset, the timing offset, or both, are based on the first precoded uplink RS and a second precoded uplink RS associated with the second TRP. The operations of 1810 may be performed in accordance with examples as disclosed herein. In some examples, aspects of the operations of 1810 may be performed by a reception component 1030 as described with reference to FIG. 10.

At 1815, the method may include outputting, to a central node, a first message indicating the first precoded uplink RS. The operations of 1815 may be performed in accordance with examples as disclosed herein. In some examples, aspects of the operations of 1815 may be performed by a transmission component 1025 as described with reference to FIG. 10.

At 1820, the method may include obtaining a second message indicating an estimation of the phase offset, the timing offset, or both, from the central node in response to the first message, where the estimation of the phase offset, the timing offset, or both are based on a product of the first precoded uplink RS and a conjugate of the second precoded uplink RS. The operations of 1820 may be performed in accordance with examples as disclosed herein. In some examples, aspects of the operations of 1820 may be performed by an offset estimation component 1035 as described with reference to FIG. 10.

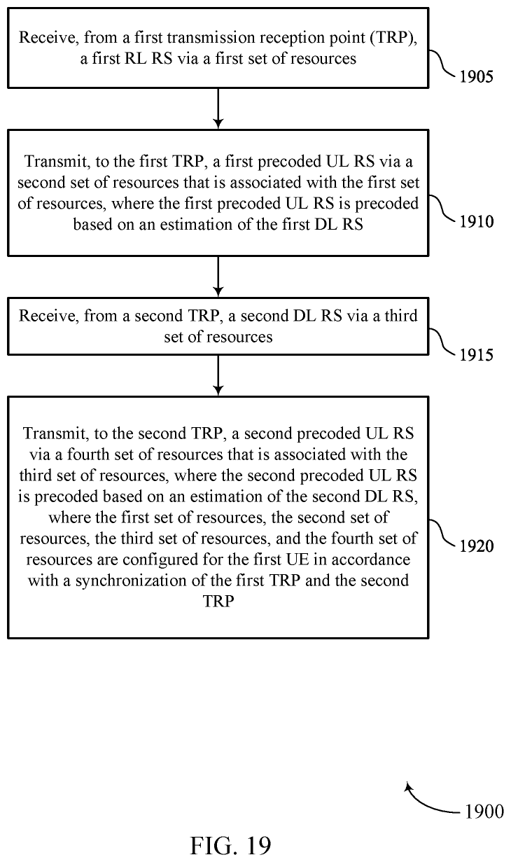

FIG. 19 shows a flowchart illustrating a method 1900 that supports UE-assisted time and phase synchronization for CJT in accordance with aspects of the present disclosure. The operations of the method 1900 may be implemented by a UE or its components as described herein. For example, the operations of the method 1900 may be performed by a UE 115 as described with reference to FIGS. 1 through 7 and 12 through 15. In some examples, a UE may execute a set of instructions to control the functional elements of the UE to perform the described functions. Additionally, or alternatively, the UE may perform aspects of the described functions using special-purpose hardware.

At 1905, the method may include receiving, from a first TRP, a first downlink RS via a first set of resources. The operations of 1905 may be performed in accordance with examples as disclosed herein. In some examples, aspects of the operations of 1905 may be performed by a reception component 1425 as described with reference to FIG. 14.

At 1910, the method may include transmitting, to the first TRP, a first precoded uplink RS via a second set of resources that is associated with the first set of resources, where the first precoded uplink RS is precoded based on an estimation of the first downlink RS. The operations of 1910 may be performed in accordance with examples as disclosed herein. In some examples, aspects of the operations of 1910 may be performed by a transmission component 1430 as described with reference to FIG. 14.

At 1915, the method may include receiving, from a second TRP, a second downlink RS via a third set of resources. The operations of 1915 may be performed in accordance with examples as disclosed herein. In some examples, aspects of the operations of 1915 may be performed by a reception component 1425 as described with reference to FIG. 14.

At 1920, the method may include transmitting, to the second TRP, a second precoded uplink RS via a fourth set of resources that is associated with the third set of resources, where the second precoded uplink RS is precoded based on an estimation of the second downlink RS, where the first set of resources, the second set of resources, the third set of resources, and the fourth set of resources are configured for the first UE in accordance with a synchronization of the first TRP and the second TRP. The operations of 1920 may be performed in accordance with examples as disclosed herein. In some examples, aspects of the operations of 1920 may be performed by a transmission component 1430 as described with reference to FIG. 14.

The following provides an overview of aspects of the present disclosure:

Aspect 1: A method for wireless communication at a first TRP, comprising: transmitting, to a first UE, a first downlink RS via a first set of resources; and receiving, from the first UE, a first precoded uplink RS via a second set of resources that is associated with the first set of resources, the first precoded uplink RS being precoded based at least in part on an estimation of the first downlink RS, wherein the first TRP synchronizes with a second TRP in accordance with a phase offset, a timing offset, or both, between the first TRP and the second TRP, and wherein the phase offset, the timing offset, or both, are based at least in part on the first precoded uplink RS and a second precoded uplink RS associated with the second TRP.

Aspect 2: The method of aspect 1, further comprising: receiving, from the second TRP, a message indicating the second precoded uplink RS; and estimating the phase offset, the timing offset, or both, based at least in part on a product of the first precoded uplink RS and a conjugate of the second precoded uplink RS.

Aspect 3: The method of aspect 2, wherein the estimation of the phase offset, the timing offset, or both is based at least in part on a computation of the product of the first precoded uplink RS and the conjugate of the second precoded uplink RS for a plurality of subcarriers.

Aspect 4: The method of any of aspects 1 through 3, further comprising: outputting, to a central node, a first message indicating the first precoded uplink RS; and obtaining a second message indicating an estimation of the phase offset, the timing offset, or both, from the central node in response to the first message, wherein the estimation of the phase offset, the timing offset, or both are based at least in part on a product of the first precoded uplink RS and a conjugate of the second precoded uplink RS.

Aspect 5: The method of aspect 4, wherein the estimation of the phase offset, the timing offset, or both is based at least in part on a computation of the product of the first precoded uplink RS and the conjugate of the second precoded uplink RS for a plurality of subcarriers.

Aspect 6: The method of any of aspects 4 through 5, wherein the central node comprises one of the second TRP or another network entity.

Aspect 7: The method of any of aspects 1 through 6, wherein the second precoded uplink RS is associated with a second downlink RS that corresponds to a third set of resources, and wherein the second precoded uplink RS is precoded based at least in part on the second downlink RS and corresponds to a fourth set of resources associated with the third set of resources, the method further comprising: obtaining the phase offset, the timing offset, or both based at least in part on a product of the first precoded uplink RS and a conjugate of the second precoded uplink RS, and further based at least in part on a subcarrier spacing index associated with the first set of resources, the second set of resources, the third set of resources, the fourth set of resources, or any combination thereof.

Aspect 8: The method of aspect 7, wherein a frequency resource of the first set of resources has a same frequency as a corresponding frequency resource of the third set of resources, or a frequency resource of the second set of resources has a same frequency as a corresponding frequency resource of the fourth set of resources, or both.

Aspect 9: The method of any of aspects 7 through 8, wherein a time resource of the first set of resources is the same as a corresponding time resource of the third set of resources, or a time resource of the second set of resources is the same as a corresponding time resource of the fourth set of resources, or both.

Aspect 10: The method of any of aspects 7 through 9, wherein a time resource of the first set of resources is the same as a corresponding time resource of the third set of resources and a frequency resource of the second set of resources has a same frequency as a corresponding frequency resource of the fourth set of resources.

Aspect 11: The method of any of aspects 7 through 10, further comprising: determining a threshold timing offset associated with synchronization based at least in part on a frequency spacing between the first set of resources, the second set of resources, the third set of resources, the fourth set of resources, or a combination thereof; and determining a threshold offset resolution based at least in part on a bandwidth for the first precoded uplink RS, the second precoded uplink RS, the first downlink RS, the second downlink RS, or any combination thereof.

Aspect 12: The method of any of aspects 1 through 11, further comprising: synchronizing a timing or a phase, or both, with a third TRP based at least in part on a second phase offset, a second timing offset, or both, between the second TRP and a third TRP, wherein the first TRP synchronizes with the third TRP using a combination of the phase offset and the second phase offset, a combination of the timing offset and the second timing offset, or both.

Aspect 13: The method of aspect 12, wherein the second phase offset, the second timing offset, or both, are based at least in part on a third precoded uplink RS transmitted from a second UE to the second TRP and a fourth precoded uplink RS transmitted from the second UE to the third TRP.

Aspect 14: The method of any of aspects 1 through 13, further comprising: transmitting, to the first UE, a control message comprising an indication that the first set of resources for the first downlink RS are associated with the second set of resources for the first precoded uplink RS

Aspect 15: The method of any of aspects 1 through 14, further comprising: receiving capability signaling indicating a capability of the first UE to provide the first precoded uplink RS to the first TRP to assist with synchronization of the first TRP and the second TRP.

Aspect 16: The method of aspect 15, wherein the capability signaling indicates a capability of the first UE to support simultaneous downlink RS reception, a capability of the first UE to support simultaneous uplink RS transmission, one or more RS structures the first UE supports, a range of time and frequency resources that transmission and reception characteristics of the first UE are consistent, a maximum quantity of TRPs to which the first UE is capable of providing precoded uplink RSs, a capability of the first UE to maintain reception phase continuity and transmission phase continuity in a quantity of symbols, or any combination thereof.

Aspect 17: The method of any of aspects 1 through 16, wherein the first downlink RS comprises one of a tracking reference signal, a positioning reference signal, an SSB, or a DMRS.

Aspect 18: A method for wireless communication at a first UE, comprising: receiving, from a first TRP, a first downlink RS via a first set of resources; transmitting, to the first TRP, a first precoded uplink RS via a second set of resources that is associated with the first set of resources, wherein the first precoded uplink RS is precoded based at least in part on an estimation of the first downlink RS; receiving, from a second TRP, a second downlink RS via a third set of resources; and transmitting, to the second TRP, a second precoded uplink RS via a fourth set of resources that is associated with the third set of resources, wherein the second precoded uplink RS is precoded based at least in part on an estimation of the second downlink RS, wherein the first set of resources, the second set of resources, the third set of resources, and the fourth set of resources are configured for the first UE in accordance with a synchronization of the first TRP and the second TRP.

Aspect 19: The method of aspect 18, wherein a frequency resource of the first set of resources has a same frequency as a corresponding frequency resource of the third set of resources, a frequency resource of the second set of resources has a same frequency as a corresponding frequency resource of the fourth set of resources, or both.

Aspect 20: The method of any of aspects 18 through 19, wherein a time resource of the first set of resources is the same as a corresponding time resource of the third set of resources, a time resource of the second set of resources is the same as a corresponding time resource of the fourth set of resources, or both.

Aspect 21: The method of any of aspects 18 through 20, wherein a time resource of the first set of resources is the same as a corresponding time resource of the third set of resources, and a the frequency resource of the second set of resources has a same frequency as a corresponding frequency resource of the fourth set of resources.

Aspect 22: The method of any of aspects 18 through 21, further comprising: receiving a control message comprising an indication that the first set of resources for the first downlink RS are associated with the second set of resources for the first precoded uplink RS.

Aspect 23: The method of any of aspects 18 through 22, further comprising: receiving control signaling comprising a first indication that the first set of resources for the first downlink RS are associated with the second set of resources for the first precoded uplink RS, and a second indication that the third set of resources for the second downlink RS are associated with the fourth set of resources for the second precoded uplink RS.

Aspect 24: The method of aspect 23, wherein the control signaling comprises one or more uplink RS configurations, one or more downlink reference configurations, one or more pointers associated with uplink RS resource identifiers or downlink RS identifiers, or any combination thereof.

Aspect 25: The method of any of aspects 18 through 24, wherein the first downlink RS, the second downlink RS, the first precoded uplink RS, and the second precoded uplink RS each comprise multiple instances transmitted at respective frequency spacings, the method further comprising: interpolating between the respective frequency spacings of the multiple instances of the first downlink RS and between the respective frequency spacings of the multiple instances of the second downlink RS, wherein the estimation of the first downlink RS and the estimation of the second downlink RS is based at least in part on the interpolating.

Aspect 26: The method of any of aspects 18 through 25, further comprising: transmitting capability signaling indicating a capability of the first UE to provide the first precoded uplink RS to the first TRP to assist with synchronization of the first TRP and the second TRP.

Aspect 27: The method of aspect 26, wherein the capability signaling indicates a capability of the first UE to support simultaneous downlink RS reception, a capability of the first UE to support simultaneous uplink RS transmission, one or more RS structures the first UE supports, a range of time and frequency resources that transmission and reception characteristics of the first UE are consistent, a maximum quantity of TRPs to which the first UE is capable of providing precoded uplink RSs, a capability of the first UE to maintain reception phase continuity and transmission phase continuity in a quantity of symbols, or any combination thereof.

Aspect 28: The method of any of aspects 18 through 27, further comprising: receiving, from a third TRP, a third downlink RS via a fifth set of resources; and transmitting, to the third TRP, a third precoded uplink RS via a sixth set of resources that is associated with the fifth set of resources, wherein the third precoded uplink RS is precoded based at least in part on an estimation of the third downlink RS.

Aspect 29: A first TRP for wireless communication, comprising one or more memories storing processor-executable code, and one or more processors coupled with the one or more memories and individually or collectively operable to execute the code to cause the first transmission and reception point (TRP) to perform a method of any of aspects 1 through 17.

Aspect 30: A first TRP for wireless communication, comprising at least one means for performing a method of any of aspects 1 through 17.

Aspect 31: A non-transitory computer-readable medium storing code for wireless communication, the code comprising instructions executable by one or more processors to perform a method of any of aspects 1 through 17.

Aspect 32: A first UE for wireless communication, comprising one or more memories storing processor-executable code, and one or more processors coupled with the one or more memories and individually or collectively operable to execute the code to cause the first UE to perform a method of any of aspects 18 through 28.

Aspect 33: A first UE for wireless communication, comprising at least one means for performing a method of any of aspects 18 through 28.

Aspect 34: A non-transitory computer-readable medium storing code for wireless communication, the code comprising instructions executable by one or more processors to perform a method of any of aspects 18 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first transmission and reception point (TRP), comprising:
one or more memories storing processor-executable code; and
one or more processors coupled with the one or more memories and individually or collectively operable to execute the code to cause the first TRP to:
transmit, to a first user equipment (UE), a first downlink reference signal via a first set of resources; and
receive, from the first UE, a first precoded uplink reference signal via a second set of resources that is associated with the first set of resources, the first precoded uplink reference signal being precoded based at least in part on an estimation of the first downlink reference signal, wherein the first TRP synchronizes with a second TRP in accordance with a phase offset, a timing offset, or both, between the first TRP and the second TRP, and wherein the phase offset, the timing offset, or both, are based at least in part on the first precoded uplink reference signal and a second precoded uplink reference signal associated with the second TRP.

2. The first TRP of claim 1, wherein the one or more processors are individually or collectively further operable to execute the code to cause the first TRP to:
receive, from the second TRP, a message indicating the second precoded uplink reference signal; and
estimate the phase offset, the timing offset, or both, based at least in part on a product of the first precoded uplink reference signal and a conjugate of the second precoded uplink reference signal.

3. The first TRP of claim 2, wherein the estimation of the phase offset, the timing offset, or both is based at least in part on a computation of the product of the first precoded uplink reference signal and the conjugate of the second precoded uplink reference signal for a plurality of subcarriers.

4. The first TRP of claim 1, wherein the one or more processors are individually or collectively further operable to execute the code to cause the first TRP to:
outputting, to a central node, a first message indicate the first precoded uplink reference signal; and
obtain a second message indicating an estimation of the phase offset, the timing offset, or both, from the central node in response to the first message, wherein the estimation of the phase offset, the timing offset, or both are based at least in part on a product of the first precoded uplink reference signal and a conjugate of the second precoded uplink reference signal.

5. The first TRP of claim 4, wherein the estimation of the phase offset, the timing offset, or both is based at least in part on a computation of the product of the first precoded uplink reference signal and the conjugate of the second precoded uplink reference signal for a plurality of subcarriers.

6. The first TRP of claim 4, wherein the central node comprises one of the second TRP or another network entity.

7. The first TRP of claim 1, wherein the second precoded uplink reference signal is associated with a second downlink reference signal that corresponds to a third set of resources, and wherein the second precoded uplink reference signal is precoded based at least in part on the second downlink reference signal and corresponds to a fourth set of resources associated with the third set of resources, and the one or more processors are individually or collectively further operable to execute the code to cause the first TRP to:
obtain the phase offset, the timing offset, or both based at least in part on a product of the first precoded uplink reference signal and a conjugate of the second precoded uplink reference signal, and further based at least in part on a subcarrier spacing index associated with the first set of resources, the second set of resources, the third set of resources, the fourth set of resources, or any combination thereof.

8. The first TRP of claim 7, wherein a frequency resource of the first set of resources has a same frequency as a corresponding frequency resource of the third set of resources, or a frequency resource of the second set of resources has a same frequency as a corresponding frequency resource of the fourth set of resources, or both.

9. The first TRP of claim 7, wherein a time resource of the first set of resources is the same as a corresponding time resource of the third set of resources, or a time resource of the second set of resources is the same as a corresponding time resource of the fourth set of resources, or both.

10. The first TRP of claim 7, wherein a time resource of the first set of resources is the same as a corresponding time resource of the third set of resources and a frequency resource of the second set of resources has a same frequency as a corresponding frequency resource of the fourth set of resources.

11. The first TRP of claim 7, wherein the one or more processors are individually or collectively further operable to execute the code to cause the first TRP to:
determine a threshold timing offset associated with synchronization based at least in part on a frequency spacing between the first set of resources, the second set of resources, the third set of resources, the fourth set of resources, or a combination thereof; and
determine a threshold offset resolution based at least in part on a bandwidth for the first precoded uplink reference signal, the second precoded uplink reference signal, the first downlink reference signal, the second downlink reference signal, or any combination thereof.

12. The first TRP of claim 1, wherein the one or more processors are individually or collectively further operable to execute the code to cause the first TRP to:
synchronize a timing or a phase, or both, with a third TRP based at least in part on a second phase offset, a second timing offset, or both, between the second TRP and a third TRP, wherein the first TRP synchronizes with the third TRP using a combination of the phase offset and the second phase offset, a combination of the timing offset and the second timing offset, or both.

13. The first TRP of claim 12, wherein the second phase offset, the second timing offset, or both, are based at least in part on a third precoded uplink reference signal transmitted from a second UE to the second TRP and a fourth precoded uplink reference signal transmitted from the second UE to the third TRP.

14. The first TRP of claim 1, wherein the one or more processors are individually or collectively further operable to execute the code to cause the first TRP to:
transmit, to the first UE, a control message comprising an indication that the first set of resources for the first downlink reference signal are associated with the second set of resources for the first precoded uplink reference signal.

15. The first TRP of claim 1, wherein the one or more processors are individually or collectively further operable to execute the code to cause the first TRP to:
receive capability signaling indicating a capability of the first UE to provide the first precoded uplink reference signal to the first TRP to assist with synchronization of the first TRP and the second TRP.

16. The first TRP of claim 15, wherein the capability signaling indicates a capability of the first UE to support simultaneous downlink reference signal reception, a capability of the first UE to support simultaneous uplink reference signal transmission, one or more reference signal structures the first UE supports, a range of time and frequency resources for which transmission and reception characteristics of the first UE are consistent, a threshold quantity of TRPs to which the first UE is capable of providing precoded uplink reference signals, a capability of the first UE to maintain reception phase continuity and transmission phase continuity in a quantity of symbols, or any combination thereof.

17. The first TRP of claim 1, wherein the first downlink reference signal comprises one of a tracking reference signal, a positioning reference signal, a synchronization signal block, or a demodulation reference signal.

18. A first user equipment (UE), comprising:
one or more memories storing processor-executable code; and
one or more processors coupled with the one or more memories and individually or collectively operable to execute the code to cause the first UE to:
receive, from a first transmission reception point (TRP), a first downlink reference signal via a first set of resources;
transmit, to the first TRP, a first precoded uplink reference signal via a second set of resources that is associated with the first set of resources, wherein the first precoded uplink reference signal is precoded based at least in part on an estimation of the first downlink reference signal;
receive, from a second TRP, a second downlink reference signal via a third set of resources; and
transmit, to the second TRP, a second precoded uplink reference signal via a fourth set of resources that is associated with the third set of resources, wherein the second precoded uplink reference signal is precoded based at least in part on an estimation of the second downlink reference signal, wherein the first set of resources, the second set of resources, the third set of resources, and the fourth set of resources are configured for the first UE in accordance with a synchronization of the first TRP and the second TRP.

19. The first UE of claim 18, wherein a frequency resource of the first set of resources has a same frequency as a corresponding frequency resource of the third set of resources, a frequency resource of the second set of resources has a same frequency as a corresponding frequency resource of the fourth set of resources, or both.

20. The first UE of claim 18, wherein a time resource of the first set of resources is the same as a corresponding time resource of the third set of resources, a time resource of the second set of resources is the same as a corresponding time resource of the fourth set of resources, or both.

21. The first UE of claim 18, wherein a time resource of the first set of resources is the same as a corresponding time resource of the third set of resources, and a the frequency resource of the second set of resources has a same frequency as a corresponding frequency resource of the fourth set of resources.

22. The first UE of claim 18, wherein the one or more processors are individually or collectively further operable to execute the code to cause the first UE to:
receive a control message comprising an indication that the first set of resources for the first downlink reference signal are associated with the second set of resources for the first precoded uplink reference signal.

23. The first UE of claim 18, wherein the one or more processors are individually or collectively further operable to execute the code to cause the first UE to:
receive control signaling comprising a first indication that the first set of resources for the first downlink reference signal are associated with the second set of resources for the first precoded uplink reference signal, and a second indication that the third set of resources for the second downlink reference signal are associated with the fourth set of resources for the second precoded uplink reference signal.

24. The first UE of claim 23, wherein the control signaling comprises one or more uplink reference signal configurations, one or more downlink reference configurations, one or more pointers associated with uplink reference signal resource identifiers or downlink reference signal identifiers, or any combination thereof.

25. The first UE of claim 18, wherein the first downlink reference signal, the second downlink reference signal, the first precoded uplink reference signal, and the second precoded uplink reference signal each comprise multiple instances transmitted at respective frequency spacings, and the one or more processors are individually or collectively further operable to execute the code to cause the first UE to:
interpolate between the respective frequency spacings of the multiple instances of the first downlink reference signal and between the respective frequency spacings of the multiple instances of the second downlink reference signal, wherein the estimation of the first downlink reference signal and the estimation of the second downlink reference signal is based at least in part on the interpolating.

26. The first UE of claim 18, wherein the one or more processors are individually or collectively further operable to execute the code to cause the first UE to:
transmit capability signaling indicating a capability of the first UE to provide the first precoded uplink reference signal to the first TRP to assist with synchronization of the first TRP and the second TRP.

27. The first UE of claim 26, wherein the capability signaling indicates a capability of the first UE to support simultaneous downlink reference signal reception, a capability of the first UE to support simultaneous uplink reference signal transmission, one or more reference signal structures the first UE supports, a range of time and frequency resources for which transmission and reception characteristics of the first UE are consistent, a threshold quantity of TRPs to which the first UE is capable of providing precoded uplink reference signals, a capability of the first UE to maintain reception phase continuity and transmission phase continuity in a quantity of symbols, or any combination thereof.

28. The first UE of claim 18, wherein the one or more processors are individually or collectively further operable to execute the code to cause the first UE to:
receive, from a third TRP, a third downlink reference signal via a fifth set of resources; and
transmit, to the third TRP, a third precoded uplink reference signal via a sixth set of resources that is associated with the fifth set of resources, wherein the third precoded uplink reference signal is precoded based at least in part on an estimation of the third downlink reference signal.

29. A method for wireless communication at a first TRP, comprising:
transmitting, to a first user equipment (UE), a first downlink reference signal via a first set of resources; and
receiving, from the first UE, a first precoded uplink reference signal via a second set of resources that is associated with the first set of resources, the first precoded uplink reference signal being precoded based at least in part on an estimation of the first downlink reference signal, wherein the first TRP synchronizes with a second TRP in accordance with a phase offset, a timing offset, or both, between the first TRP and the second TRP, and wherein the phase offset, the timing offset, or both, are based at least in part on the first precoded uplink reference signal and a second precoded uplink reference signal associated with the second TRP.

30. A method for wireless communication at a first user equipment (UE), comprising:
receiving, from a first transmission reception point (TRP), a first downlink reference signal via a first set of resources;
transmitting, to the first TRP, a first precoded uplink reference signal via a second set of resources that is associated with the first set of resources, wherein the first precoded uplink reference signal is precoded based at least in part on an estimation of the first downlink reference signal;
receiving, from a second TRP, a second downlink reference signal via a third set of resources; and
transmitting, to the second TRP, a second precoded uplink reference signal via a fourth set of resources that is associated with the third set of resources, wherein the second precoded uplink reference signal is precoded based at least in part on an estimation of the second downlink reference signal, wherein the first set of resources, the second set of resources, the third set of resources, and the fourth set of resources are configured for the first UE in accordance with a synchronization of the first TRP and the second TRP.
